(19) United States
(12) Patent Application Publication
(10) Pub. No.: US 2004/0040832 A1
(43) Pub. Date: Mar. 4, 2004

(54) Device and process for the purification of a gaseous effluent

(76) Inventors: Benoit Kartheuser, Ciney (BE); Bronislav Henri May, Overijse (BE); Jean-Francois Despres, Louvain-la-Neuve (BE)

Correspondence Address: William M. Lee, Jr., Barnes & Thornburg, P.O. Box 2786, Chicago, IL, 60690-2786, US

(21) Appl. No.: 10/463,306

(22) Filed: Jun. 16, 2003

Related U.S. Application Data
(63) Continuation-in-part of application No. PCT/EP01/14742, filed on Dec. 13, 2001.

(30) Foreign Application Priority Data
Dec. 15, 2000 (EP) 00870303.5

(51) Int. Cl. B01D 53/00; B01J 19/08

(52) U.S. Cl. 204/157.3; 422/186.3

(57) ABSTRACT

The invention concerns a device for purifying a gas effluent containing contaminants, comprising: a reactor including at least an inlet for the gas to be purified and at least an outlet for the purified gas ; at least an ultraviolet or visible radiation source; and at least a support element arranged inside the reactor and coated with a catalyst forming an exposed catalytic surface capable of oxidising at least partly the contaminants under the action of the ultraviolet or visible radiation. The reactor comprises at least two obstructing means, each of said obstructing means obstructing partly the flow of the gas effluent from said inlet up to said outlet and generating a turbulent gas zone on its downstream side, and a catalytic surface is arranged in each turbulent gas zone so that the turbulent gas flow is incident on said catalytic surface.

The invention is applicable to disinfection and pollution management of air and industrial gases.

This application is a continuation-in-part of International Application No. PCT/EP01/14742 filed Dec. 13, 2001, which was published in French, and which claims the benefit of European patent Application No. 00870303.5 filed Dec. 15, 2000; the disclosures of which are incorporated by reference in their entirety.

The present invention relates to a process for the purification of gaseous effluents and to a device, assembled or in kit form, for the implementation of this process. More generally, the invention relates to the field of the decontamination of gases, in particular to the purification and the reduction in pollution of the air. The invention also relates to the preservation of agricultural products.

### STATE OF THE ART

There exists a general need to remove atmospheric pollutants in a fast, certain and economical way. The term “pollutants” is understood here as meaning contaminants, in particular gaseous contaminants, the undesirable nature of which can be due to a variety of causes of which the following are only examples: harmful (debilitating or toxic) to the health of the human or animal body or to the satisfactory maintenance of the places in which, even occasionally, man or animals are present or in which man stores materials for the purpose of their subsequent use, in which case it is possible to speak of “disinfection”. This undesirable nature can also be attributed to considerations of comfort of human life, the gaseous contaminants not being harmful properly speaking but being able to be highly displeasing because of their smell, in which case it is possible to speak of “deodorization”, or because of an irritating property.

The aim, in treating this problem, is to find means having the ability to completely destroy, in a gaseous effluent, such as air, any molecule based on hydrogen, on carbon and, if appropriate, on oxygen and/or heteroatoms, such as sulfur and nitrogen, such as hydrocarbonaceous and/or halogenated solvent, protein, virus, bacterium, perfume essence, mold, pesticide, bacteriophage, and the like.

To this end, provision has been made to use a treatment for the mineralization (that is to say, for the complete destruction by oxidation into inorganic molecules) of atmospheric contaminants, in particular of volatile organic compounds, by photocatalysis under ultraviolet (hereinafter UV) or visible radiation over titanium dioxide. The advantage of this principle has been widely demonstrated. The reaction can be carried out at ambient temperature and at ambient pressure in reactors using standard construction materials, such as glass. It can make use of sources of UV or visible radiation which are simple in structure and inexpensive and which consume little energy, using atmospheric oxygen as main oxidizing agent, the purpose of the illumination means being to activate the photocatalytic particles. The reaction can completely mineralize the majority of volatile organic compounds, including those comprising heteroatoms. The economic analysis published by C. S. Turchi et al., in their report presented at Advanced oxidation technologies for water and air remedialion, London, Ontario, Canada (June 1994), shows that photocatalysis devices exhibit the advantage of a modular design and are of particular interest in the treatment of slightly polluted gaseous effluents (that is to say, for which the level of contaminants does not exceed approximately 1,000 ppm by volume) and at mean gas flow rates not exceeding approximately 34,000 m³/h. These conditions constitute the area par excellence of the treatment of air in poorly ventilated confined surroundings, such as dwellings, vehicles for individual transportation by road (automobiles, trucks) or collective transportation by rail (trains, subway systems, streetcars) and in the air (planes), animal rearing, storage areas, domestic and industrial cold stores, and the like, and of the treatment of effluents from chemical or biological reactors.

As regards the oxidation mechanism of the photocatalytic treatment of a gas, it is accepted that the effect on the titanium dioxide (in its anatase form) of photons with a sufficient energy in the range of the wavelengths of less than 400 nm makes it possible to eject an electron from the valence band of the semiconductor to its conduction band and thus to create a sufficiently stable and mobile positive hole which, when emerging at the surface of the oxide, makes it possible to create, on contact with adsorbed gaseous oxygen-comprising compounds (such as water vapor, oxygen or ozone), highly oxidizing free radicals which are largely responsible for the oxidizing reactions observed.

These observations have naturally resulted in a multitude of systems being conceived for the purpose of making practical use of the properties of titanium dioxide, of its analogs and of its derived compounds. The improvements investigated have generally related to the photocatalytic material, the photoreactor, the UV sources, the chlorination of the titanium dioxide surface, the use of ozone-comprising air, and the like. A few examples from the literature are provided below, by way of illustration. Thus, N. Takeda et al. describe, in Bull. Chem. Soc. Jpn., (1999) 72, 1615-1621, the effect of mordenite as supporting material for the titanium dioxide on the rate of photodecomposition of gaseous propionaldehyde, acetone or propane, the initial concentration of each pollutant being set at 130 μmol per liter of air. The results obtained show, for the supported catalyst, that it is possible to reduce the concentration of acetone by 90% in 2.5 hours, that of propane by 90% in 2 hours and that of propionaldehyde by 90% in 0.25 hour. Taking into account the mass of catalyst used, the volume of the reactor, the surface area of plate supporting the catalyst exposed to the light from the source and the power of the latter, various expressions for the oxidation rate can be calculated as follows from these results:

| Pollutant | μmol/h/W/g_{cata} | μmol/h/W/m² | μmol/h/W |
|---|---|---|---|
| Acetone | 17.5 | 175 | 0.07 |
| Propane | 22 | 220 | 0.088 |
| Propionaldehyde | 175 | 1,750 | 0.702 |

M. Sauer et al. describe, in Journal of Catalysis, (1994) 149, 81-91, the photocatalyzed oxidation of acetone in air at a rate of 0.29 μmol/h/W. Patent application WO 99/24277 also shows a reduction of approximately 85% in the concentration of acetone in the presence of anatase after 30 hours, corresponding to a rate of 0.228 μmol/h/W or alternatively 47 μmol/h/W/m². Yu et al. have also disclosed, in J. Phys. Chem. B, (1998) 102, 5094-7, the decomposition of acetone in the presence of a solid solution of formula Ti₁₋ₓZrₓO₂ showing an initial rate of 40 μmol/h/W/g_{cata} or alternatively 0.4 μmol.m²/h/W/g_{cata} during the first half hour, at the end of which time, however, the reduction in concentration does not exceed 3.4%. These publications show that acetone is widely accepted as model compound for the study of the parameters of a gas-solid heterogeneous photocatalytic oxidation reaction.

Very generally, a device for purifying a gaseous effluent by photocatalytic oxidation comprises:

a reactor comprising at least one inlet for the gas to be purified and at least one outlet for the purified gas,

at least one source of ultraviolet or visible radiation, and

at least one supporting element capable of being coated with a catalyst capable of at least partially oxidizing the impurities present in the gas under the action of ultraviolet or visible radiation, said supporting element being positioned inside the reactor.

U.S. Pat. Nos. 5,790,934 and 6,063,343 disclose several embodiments of a reactor intended for the photocatalytic purification of a stream of fluid (such as water or air) comprising either a surface folded into the shape of a star on which is deposited the catalyst or a large number of fins coated with catalyst, these various embodiments having in common that the stream of fluid is directed parallel to the planes of the catalytic supports. Furthermore, Japanese patent application No. 55-116433 discloses, for an unspecified photochemical reaction of a monophase system (gas or liquid system) in the presence of UV, visible or infrared light, the use of a reactor (represented in FIGS. 1 and 2 of this document) in which the blades, around which the reaction fluid flows, do not support a catalyst and, being transparent and positioned in the direction of the light rays in order to prevent the dispersion and absorption of light, cannot be provided for this purpose. In addition, the latter document specifies that the reaction is uniform and without disturbance of flow, that is to say proceeds homogeneously and without turbulence. Japanese patent application No. 11-342317 discloses a device for disinfecting air comprising an inlet section in which the gas to be treated expands, lowering its velocity, before entering a reaction region comprising horizontal ducts separated by corrugated plates, covered with titanium dioxide, with a low convexity which creates a degree of turbulence, photoirradiation sources being positioned over the path of the plates transversely to the gas stream. This device is effective for the treatment of water vapor comprising very low concentrations (up to 10 ppm) of organic compounds, such as trimethylainine or methyl mercaptan.

U.S. Pat. No. 5,919,422 discloses a purification system comprising a support (which can be a transparent material used to conduct normal light), a film of titanium oxide positioned on the support, and a source of UV light to irradiate this film. For the purification of air, this device can comprise a fan, one of the surfaces of the blades of which supports the final of titanium oxide. Thus, the air flows along the surface of the blades and turbulence can be obtained to a certain extent only by giving rotary movement to the support of the photocatalyst.

U.S. Pat. No. 5,643,436 discloses a deodorization device for interior use in which air also flows parallel to a continuous photocatalytic support without other turbulence than that created by a fan placed at the inlet of the reactor.

Patent applications EP-A-798 143 and EP-A-826 531 disclose air purification devices of folded or corrugated form supporting a photocatalyst for oxidizing sulfur compounds or removing nitrogen monoxide, the air flowing parallel to the support and the latter being designed to reduce the velocity of the air.

The international patent application published under No. WO 97/23268 discloses (see FIG. 1C) a purification system positioned horizontally, such as a circular or elliptical pipe equipped with (i) a duct for transfer of exhaust gas from the top side and (ii) separating plates mounted vertically below said duct in order to carry out the separation and the catalytic combustion of the soot particles. According to the teaching of this document, it is important, in order to choose the direction of the slope of the plates (ii), for the soot particles captured to be brought into and remain in contact, via the play of gravitational forces, with the catalytically active material applied to or between the plates.

Nevertheless, several problems remain to be solved in decontaminating, including disinfecting and deodorizing, a gaseous effluent, in particular in removing gaseous foreign materials and pollutants from the air rapidly and economically using, the principles of photocatalysis. In particular, a first problem lies in the limitation of the active surface area of photocatalyst actually accessible both to the incident light and to the gases, because of the usual porosity of the type of catalyst used. A second problem lies in the competition of the organic contaminants for the active sites, in particular when the pores are very small. As regards the latter parameter, the use of catalyst forms having specific surfaces ranging from approximately 12 m²/g to approximately 340 m²/g, and even up to 2000 m²/g in the case of silica aerogels, is recorded in the literature.

There is furthermore a general need to retain the quality of agricultural products such as fruits, vegetables, flowers and plants, and particularly to control the ripening of fruits and vegetables at different time points between harvest and when they are consumed, more particularly during their storage close to the place of harvest, during the transport from the place of harvest to the place where they are marketed to the final consumer and during the storage close to where they are marketed to the final consumer. Indeed, for most agricultural products, an uncontrolled ripening is very likely to entail the partial or complete loss of at least part of the harvest by rendering it inadequate with respect to the criteria determined by the final distributor or the final consumer, or with regard to the maintenance of the sale price, and thus to lead to important economic loss. There is also an urgent need to reduce the energy consumption during the transport or cooled storage of agricultural products between the place of harvest and the place where they are marketed to the final consumer, for instance by limiting the temperature reduction compared to the outside temperature ensured by refrigerating means during transport or storage. There is a need to maintain or control, during transport or storage of fruits and vegetables between the place of harvest and the place of market to the final consumer, the organoleptic properties of these fruits and vegetables, more particularly to maintain or control their sugar levels. Finally, there is also a need to retard the ripening of fruits so as to be able to increase the time period of availability for sale of some species or to be able to maintain more profitable prices in a time period when the species considered is only weakly present on the market. The same need exists for the retardation of the development of flowers, so as to increase their transport time for instance and thus to allow a more extended distribution.

The use of ethylene as a maturation hormone is well known and described in the literature, at levels in the order of a few parts per million (abbreviated as ppm) in the air, for products such as tomatoes, pears, apples, bananas, avocados, grapes, strawberries, nuts, etc. This same application is equally known for flowers and plants. Ethylene is produced by well known biochemical processes during the ripening of fruits. It is a self-stimulating phenomenon and tends to be emphasized by cold storage. The potential to produce ethylene and the sensitivity thereto of each type of fruit or vegetable are extremely variable from one species to another. The storage of different products or of products of different maturation levels within one species is generally avoided.

### SUMMARY OF THE INVENTION

One of the aims of the present invention consists in solving at least one of the above mentioned technical problems. This object is achieved by providing a device for the purification of a gaseous effluent by photocatalysis with an efficiency, measured by the rate of removal of one or more contaminants and expressed per units of time and of light power (and, if appropriate, per unit of catalytic surface area exposed (illuminated) or per unit of catalyst mass or alternatively per unit of surface density of catalyst), significantly greater than that of the processes known to date. Yet another aim of the present invention consists in providing a device for the purification of a gaseous effluent which is compact in design and therefore easy to incorporate in or to combine with an existing gas treatment device, such as, for example, an air conditioning device. Another aim of the present invention consists in providing a gas purification process capable of efficiently treating gaseous effluents with a level of contaminants which can reach up to approximately 10% (100,000 ppm) by volume. Yet another aim of the present invention consists in providing a device for the purification of a gaseous effluent which is simple in design and easy to maintain, which can be mass produced from inexpensive materials involving simple and well known assembling techniques, and which can be made use of in complete safety in an inexpensive process for the purification of a gaseous effluent for a great diversity of contaminants.

The present invention is based on the surprising discovery that the solution to the above-mentioned technical problems lies not so much, as suggested in the state of the art, in the amount or the choice of the photo-oxidation catalyst as in other factors, such as:

first, the internal arrangement of the reaction device, in particular in the positioning of the catalyst supporting elements with respect to the direction of flow of the gas stream and more particularly in the fact that these catalyst supporting elements, if appropriate in combination with other means for blocking the gas flow and/or with additional means for generating turbulence, are positioned so as to provide turbulent flow, at any point of the exposed catalytic surface, of the gaseous effluent to be purified, so as to promote the transportation of the impurities or contaminants to be oxidized and/or of the oxidation products from these impurities toward the catalyst;

secondly, more efficient use of the light energy by covering the reactor with a reflective surface itself, if appropriate, coated with a photosensitive catalyst.

The present invention targets substantial, preferably complete, mineralization of fundamental inorganic components of the organic contaminants/impurities to be oxidized. More specifically, the invention defines a turbulence index and a minimum value of this index in order for the reactor to be subjected to flow conditions of the gaseous effluent to be purified which are capable of increasing the rate of decomposition of the contaminants and consequently of increasing the overall efficiency of the purification process. To achieve this minimum value of the turbulence index, the invention also provides for at least two blocking means (each also being denoted hereinbelow under the term of “restriction”) to be positioned inside the reactor, preferably orthogonally or quasi-orthogonally (this notion being defined hereinbelow) to the axis of the reactor, said blocking means (restrictions) preferably being sufficient in number and appropriate in shape to slow down the gaseous effluent to be purified by 10% to 90% approximately with respect to the same reactor devoid of blocking means (restriction). These blocking means (restrictions) can also advantageously be coated with catalyst. To contribute to the overall efficiency of the purification, the invention also provides for the interior of the reactor to be able to be at least partially covered with a reflective surface itself, if appropriate, coated with catalyst.

In its most general form of expression, the present invention thus relates to a process for the purification of a gaseous effluent comprising contaminants in a device comprising:

a reactor comprising at least one inlet for the gas to be purified and at least one outlet for the purified gas,

at least one source of ultraviolet or visible radiation, and

at least one supporting element positioned inside the reactor and coated with a catalyst forming an exposed catalytic surface capable of at least partially oxidizing the contaminants under the action of ultraviolet or visible radiation supplied by the source,

the presence, inside the reactor, of at least two blocking means, each of said blocking means partially blocking the flow of the gaseous effluent from said inlet as far as said outlet and each of said blocking means generating a region of turbulent gas on its downstream side with respect to the flow of the gaseous effluent, the surface of each of said blocking means, as projected onto a plane orthogonal to the longitudinal axis of the reactor, occupying at least ⅓ (one third) of the internal cross section of the reactor available for the flow of the gaseous effluent, and a catalytic surface being positioned in each said region of turbulent gas so that the flow of turbulent gas is incident to said catalytic surface.

According to an advantageous embodiment of the invention, at least one of said blocking means is a supporting element.

The efficiency of such a device is such that it makes it possible to carry out a process for the purification of a gaseous effluent comprising contaminants while oxidizing 90% of a model impurity composed of acetone at a rate much greater than known in the prior art and which can be expressed by any one of the following units:

at least approximately 1 μmol of model impurity per hour, per watt of power of the source and per unit of surface density (expressed in grams per square meter) of catalyst,

at least approximately 300 μmol of model impurity per hour, per watt of power of the source and per square meter of exposed catalytic surface area (comprising the surface area of supporting element illuminated by the source), or else

at least approximately 100 μmol of model impurity per hour, per watt of power of the source and per grain of catalyst, or alternatively

at least approximately 2 μmol of model impurity per hour and per watt of power of the source.

As expressed here and throughout the remainder of the description, each of the minimum rates for oxidation of 90% of model impurity indicated above as characteristics of the process according to the invention should be understood as the mean rate (calculated between the beginning of the photocatalytic oxidation and the time when 90% of the model impurity has disappeared) measured under standardized conditions, that is to say at atmospheric pressure at 25° C. in air at a relative humidity level of 50%, and for initial concentrations of model impurity in the gas stream (in particular air) at least equal to 500 ppm by volume. This is because it is well known to a person skilled in the art in the field under consideration that the rate of purification decreases when the initial concentration of the impurity to be purified decreases.

Preferably, the turbulent conditions of flow of the gas to be purified are characterized by a turbulence index, calculated according to the formula I_{T}═Re*N/βf, in which

Re* is a number expressed by Re*=(4ρVₘS)/(Pν),

β=s/S is a porosity parameter, the value of which is equal to 1 if no blocking means is present inside the reactor,

f is a friction factor corresponding to the ratio of the combined surface area in the reactor to the surface area developed by the reactor in the absence of blocking means, equal to the sum of internal surface areas developed by the reactor/surface area of a cylinder with a perimeter P,

S is the mean surface area of the internal orthogonal cross section of the reactor in the absence of blocking means,

ρ is the density of the gaseous effluent to be purified,

Vₘ is the mean velocity of the gaseous effluent to be purified parallel to the longitudinal axis of the reactor,

P is the sum of the mean internal perimeter of the reactor and of the mean external perimeter of the smaller geometric envelope comprising the radiation source(s), when the latter is (are) positioned inside the reactor,

ν is the dynamic viscosity of the gaseous effluent to be purified,

N is the number of blocking means in the reactor or else, in the absence of blocking means, is equal to 1, and

s is the mean surface area of the opening defined by the internal orthogonal cross section of the reactor at the greatest extent of the blocking means, at least equal to 2,000, preferably at least 50,000 and

more preferably at least 1,000,000.

These turbulent conditions of flow of the gaseous effluent to be purified can, whatever the inherent characteristics (density, dynamic viscosity) of the said gas, be easily achieved by a proper selection of certain geometric parameters of the device, such as the number and extent of the blocking means, and the internal cross orthogonal cross section and mean internal perimeter of the reactor.

Preferably, according to the present invention, the source of ultraviolet or visible radiation is positioned inside the reactor. However, the invention is not limited to this embodiment and also includes the possibility of placing the source of ultraviolet or visible radiation outside the reactor, provided, however, that the reactor is then transparent to the radiation.

In accordance with the above mentioned aims and with the technical problem to be solved, the process according to the invention is capable of predominantly mineralizing the organic contaminants or impurities present in the gaseous effluent, that is to say of converting more than 50 mol% of said contaminants to corresponding fundamental inorganic components, such as, in particular, carbon dioxide, water, nitrogen, hydrogen halide, SO₃ and sulfates.

In another aspect, the invention consists in a process for controlling or preserving the quality of agricultural products in the gaseous atmosphere of a closed space or room, comprising a treatment step consisting in subjecting said gaseous atmosphere to a photocatalytic oxidation process according to a turbulent flow regimen, preferably defined by a turbulence index at least equal to 2,000, more preferably at least 50,000, and still more preferably at least 1,000,000. Carrying out the invention allows for the degradation of ethylene, in a room wherein the ethylene content is already relatively low (about 10 to 300 ppm, until the ethylene content does not exceed 1 ppm, preferably 0.5 ppm. In addition to substantial economic advantages, this process allows for significantly improving the organoleptic quality and properties of the fruits and vegetables thus treated, in particular controlling their sugar content, with respect to the more traditional preservation and storing methods described hereunder.

The principles of the invention will now be stated with reference to the appended drawings and to the detailed embodiments which follow.

### BRIEF DESCRIPTION OF THE DRAWINGS

FIG. 1 represents a first embodiment of a photocatalytic reactor for the purification of gaseous effluents according to the invention.

FIG. 2 represents a second embodiment of a photocatalytic reactor for the purification of gaseous effluents according to the invention.

FIG. 3 represents a photocatalytic reactor according to the prior art used as comparative example.

FIG. 4 represents a closed circuit assembly using a photocatalytic reactor according to the invention for the purification of acetone.

FIG. 5 represents the kinetics of disappearance of acetone in a reactor according to the first embodiment of the invention, with and without reflective surface.

FIG. 6 represents the change in carbon dioxide gas produced by the process according to the invention as a function of acetone consumed.

FIG. 7 represents the change in carbon dioxide gas produced by a process of the prior art as a function of acetone consumed.

FIG. 8 represents the kinetics of disappearance of acetone in a reactor according to the first embodiment of the invention, with and without catalyst on the reflective surface.

FIG. 9 represents the kinetics of disappearance of acetone in reactors according to the first and second embodiments of the invention, that is to say with and without additional restrictions on the passage of the gas to be purified.

FIGS. 10(A and B) represents a third embodiment of a photocatalytic reactor for the purification of gaseous effluents according to the invention.

FIG. 11 represents the kinetics of disappearance of acetone in a reactor according to the third embodiment of the invention.

FIG. 12 diagrammatically represents other embodiments of a device for the purification of gaseous effluents according to the invention.

FIG. 13 schematically shows another embodiment of a photo-catalytic reactor for the preservation of agricultural products.

FIG. 14 shows the kinetics of disappearance of toluene in a reactor according to the invention.

FIG. 15 schematically shows a refrigerated trailer equipped with a device according to the invention for the preservation of fruits.

FIG. 16 shows the kinetics of disappearance of ethylene in a reactor according to the invention.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

A purification device according to an embodiment of the present invention comprises, first of all, a reactor having at least one inlet for the gaseous effluent to be purified and at least one outlet for the decontaminated gaseous effluent, within which is positioned at least one supporting element coated with a photo-oxidation catalyst, i.e. capable of at least partially oxidizing, under the action of ultraviolet or visible radiation, the impurities or contaminants present in the gaseous effluent. Preferably, the inlet of the gas and the outlet of the gas are positioned at opposite ends of the reactor, whatever the shape of the latter. They can optionally also be positioned at the same end of the reactor, the gas stream then describing a U-shaped trajectory. The reactor can have any shape, be made of any material and have any dimensions, with the proviso, however, that the shape, material and dimensions are suited to those of the blocking means and to the characteristics of the radiation source. Thus, the reactor should be composed of a material which is transparent to the radiation if the radiation source is positioned outside the reactor. Mention may be made, as non-limiting examples of materials from which the reactor may be formed, of any material which is inert with respect to ultraviolet or visible radiation and preferably capable of being covered with a reflective surface, such as glass, aluminum, galvanized steel, stainless steel, transparent synthetic resins, such as transparent poly(methyl methacrylate) or polycarbonate, and the like. Although the reactor can also be cubical or spherical in shape, it may be preferable for a longitudinal dimension of the reactor to be greater than a transverse dimension of said reactor. For this reason, parallelepipedal and cylindrical shapes are generally preferred. The dimensions of the reactor should be adapted, in a way known to a person skilled in the art, to the volume of gaseous effluent to be purified and, if appropriate, to the immediate surroundings in which said reactor is placed, for example when it is incorporated in or combined with an existing gas treatment device, Such as, for example, an air conditioning device. Preferably, the internal cross section of the reactor does not exceed approximately 50 times the internal cross section of the smaller tube which can comprise all the radiation sources. Preferably again, the length of the part of the reactor comprising the catalyst supporting elements is between 1 and 15 times approximately the internal perimeter of this reactor. By virtue of the exceptional efficiency of the device according to the invention, the dimensions of the reactor can be very small, for example of the order of a few centimeters to a few tens of centimeters for a device for domestic use and of the order of a meter or of a few meters for a device for industrial use.

In accordance with the present invention, the reactor comprises at least two blocking means, also denoted herein below under the term of restrictions, which partially block the flow of the gaseous effluent between the inlet and the outlet of the reactor and which generate a region of turbulent gas flow, and a catalytic surface is positioned in each region of turbulent gas flow so that the flow of turbulent gas is incident to said catalytic surface. Without wishing to be committed by a specific theory, it appears reasonable to hypothesize that the turbulent flow makes it possible to more efficiently supply and remove the reactants and resulting oxidation products while avoiding the creation of a concentration gradient in the immediate surroundings of the catalyst. It thus promotes the homogenization of the fluid in the immediate surroundings of the catalyst surface and optimizes the difference in chemical potential between the adsorbed products and those which are found in the gas phase in immediate contact with the solid. This is because, in contrast to a prior art, such as WO 97/23268, which requires a partially or completely molten catalyst for the separation of liquid and solid contaminants, the present invention is preferably based on a heterogeneous reaction of solid-gas type. The number and the shape of the blocking means (restrictions) are preferably chosen so as to slow down the gaseous effluent to be purified by 10% to 90% approximately with respect to the velocity which the latter would have in the same reactor in the absence of blocking means (restrictions.

The surface area of each blocking means, as projected onto a plane orthogonal to the longitudinal axis of the reactor, occupies at least ⅓ (one third) and preferably at least ½ (half) of the internal cross section of the reactor available for the passage, that is to say for the flow, of the gaseous effluent. When the radiation source is positioned inside the reactor, it relates to the cross section available between the internal wall of the reactor and above said radiation source. At least one of the blocking means (restrictions) can be a supporting element coated with catalyst. For example, if the device according to the invention comprises two blocking means, one of them can be a supporting element while the other is a restriction not coated with catalyst, or else both are supporting elements. In other words, restrictions not coated with catalyst and supporting elements differ only by the presence or absence of catalyst at their surface but have the common function, by their positioning inside the reactor, of participating in the establishment of turbulent conditions of the gas flow. With the exception of what concerns the catalyst, their characteristics will therefore now be described without distinguishing between the two. Preferably, and contrary to the prior art, which provides one or more supporting elements occupying the entire length of the reactor, the restrictions are distributed non-continuously or discontinuously along the longitudinal dimension, that is to say along a longitudinal axis, of the reactor. In other words, the reactor comprises a finite number of blocking means (restrictions) distributed at regular or irregular intervals along the reactor. The thickness and the total number of blocking means (restrictions) in the reactor are not critical parameters of the present invention, provided that they contribute to providing turbulent flow of the gaseous effluent to be purified so as to promote the transportation of the contaminants/impurities to be oxidized and/or of the oxidation products from these contaminants toward the catalyst. The number of blocking means (restrictions) not coated with catalyst is not a critical parameter of the present invention and can be less than, equal to or greater than that of the supporting elements. As a person skilled in the art readily understands, the number of blocking means (restrictions) must not be so high and their spacing must not be so slight that it results in limiting the formation of turbulent flows of the gaseous effluent between the supporting elements. In other words, the spacing of the blocking means (restrictions) must be commensurable with their transverse dimension, more particularly with the space available inside the reactor, for example that between the wall of the reactor and the geometric envelope (for example, the internal cylinder) comprising the light source or the combined light sources when the latter are positioned inside the reactor. The number of blocking means (restrictions) is also in keeping with the longitudinal dimension of the reactor. From experiments reported in the examples herein below, the a number of blocking means from approximately 2 to 20, preferably 5 to 15 approximately, is usually sufficient to produce the desired turbulent conditions. A single supporting element may prove to be sufficient, in particular when a longitudinal dimension of the reactor is not greater than a transverse dimension of said reactor.

The shape, the material and the dimensions of the blocking means, including in this the supporting elements, can be chosen within wide ranges, provided that they are positioned so as to provide turbulent flow of the gaseous effluent to be purified suitable for promoting the transportation of the contaminants/impurities to be oxidized and/or of the oxidation products from these impurities toward the catalyst, preferably a turbulent flow characterized by the turbulence index I_{T} mentioned above. Preferably, the blocking means are positioned perpendicularly or quasi-perpendicularly to the main direction, that is to say the direction of flow, of the gaseous effluent to be purified, as defined, for example (in the case of one inlet and of one outlet positioned at the opposite ends of the reactor), by the straight line connecting the inlet of the gas to be purified and the outlet of the purified gas. The term “quasi-perpendicularly” should be understood to mean, within the present invention, that the mean plane (for example, the plane of symmetry) in which the blocking means occurs, forms, with the main direction of flow of the gaseous effluent to be purified, an angle of between 60° and 120°, preferably of between 70° and 110° approximately and more preferably of between 80° and 100° approximately. For example, the blocking means can be a structure which is flat and thin, that is to say low in thickness with respect to the (longitudinal) dimension of the reactor, with a shape identical to or similar to or different from the transverse cross section of the reactor, and, if appropriate, centered on the axis of the reactor or on the axis of the radiation source. This shape can be a disk, an ellipse, a polygon or any other geometric shape appropriate for good contact with the contaminants to be oxidized and easy to manufacture in an inexpensive way.

According to an advantageous embodiment of the present invention, the source(s) of ultraviolet or visible radiation is (are) placed along the longitudinal axis of the reactor and, in this case, each blocking means is preferably provided with a hole (with a shape suited to that of the source) at its center so as to be positioned around the source but perpendicularly or quasi-perpendicularly to the axis of the reactor.

The nature of the material constituting the blocking means of the device according to the invention is not a critical parameter of the present invention. Any material with a strength known to be able to withstand on a long term basis the effect of ultraviolet or visible radiation, the turbulence of the gaseous stream and, when the blocking means is a supporting element, a photooxidation catalyst can be used in the context of the present invention. Non-limiting examples of such materials are glass and metals, preferably metals offering satisfactory reflection of the light radiation, such as aluminum or stainless steel. The supporting element can comprise a porous surface or structure, such as a metal grid or screen, capable of receiving the deposition of a photooxidation catalyst.

The source of ultraviolet or visible radiation forming part of the device according to 2 0 the invention is preferably a commercially available standard source of radiation. A suitable ultraviolet radiation source may radiate energy within a range of wavelengths of less than approximately 400 nm. A suitable visible radiation source may radiate energy within a range of wavelengths of 400 to 700 nm approximately. The type of construction (in particular the material and the geometry) and the method of operation (in particular the emitting gas) of the source are not critical parameters of the present invention. Mention may in particular be made, as examples of ultraviolet radiation sources, of low-pressure sources comprising a mercury, neon, argon, krypton or xenon gas or their mixtures, as is well known to a person skilled in the art. The envelope of the source can conventionally be composed of a tube of ceramic, of ordinary glass (silica or molten quartz) or of reduced solarization glass (according to the long-lasting source technology developed by Philips) and can, if appropriate, be coated with phosphorus. The nominal power of the source, that is to say its power consumed, is not a critical parameter of the present invention and can be for example within the range of 2 to 500 watts approximately. However, because of the exceptional efficiency of the device according to the invention, it need not be necessary to use high-power sources, as in the prior art. As is confirmed by the experiments reported in the following examples, it is desirable for the source to provide a mean light intensity over the photocatalyst, i.e. a power per unit of surface area of photocatalyst illuminated, of about 1 to 500 mW/cm², preferably 2 to 300 mW/cm², more preferably 2 to 20 mW/cm². According to the present invention, the source of ultraviolet or visible radiation can also be a source of natural light, illuminating from the outside of the reactor, or else by means of wave guides with possible formation of thermal convection.

According to another advantageous embodiment of the present invention, the interior of the reactor is at least partially covered with a reflective surface, that is to say a surface capable of reflecting a substantial part of the ultraviolet or visible radiation of the source, such as, for example, be constructed using a reflective material or a material covered with a reflective coating, or else covered with a thin aluminum sheet (25 to 100 μm approximately). The nature of the reflective surface is not a critical parameter of the present invention, subject to the level of reflection of the ultraviolet or visible radiation. According to an alternative form of this embodiment, the reflective surface can be coated, preferably as a very fine layer (in order not to excessively lower the level of reflection of the ultraviolet or visible radiation), with a catalyst capable of at least partially oxidizing the contaminants/impurities present in the gaseous effluent under the action of the ultraviolet or visible radiation of the source, that is to say a photooxidation catalyst. This catalyst can be the same as that deposited on the supporting elements or else another catalyst. Preferably, the reflective surface (in the absence of deposition of catalyst) provides, in the range of wavelengths of the ultraviolet or visible radiation under consideration, a reflection of greater than approximately 50% (as measured according to a standard technique involving an integration sphere) and more particularly of greater than 80%. This reflective surface can support a layer of photooxidation catalyst with a thickness such that it is capable of absorbing at most 65% approximately of the light which is active from a photochemical view point. The reflective surface, when it is coated with such a catalyst, therefore preferably reflects at least 20% approximately, preferably at least 50% approximately, of the photochemically active light.

The device according to the invention can additionally comprise or be functionally combined with means suitable for accentuating turbulent flow of the gas to be purified in the reactor, such as, for example, forced ventilation means or thermal convection means. Preferably, said means for accentuating the turbulence are placed close to the inlet of the reactor for better effectiveness. The term “functionally combined with” is understood to mean that these means are not necessarily connected to the reactor by a physical connecting means, such as a rod or other coupling system, but, by their positioning with respect to the reactor, act in synergy with the blocking means to increase the turbulence index (as defined above) or the turbulent nature of the flow conditions in the reactor. In the absence of a physical connection between these elements, the present invention thus also relates to a kit comprising, on the one hand, the means for accentuating the turbulence and, on the other hand, the device for the purification of a gaseous effluent as described above. Preferably, said means for accentuating the turbulence make it possible to provide, alone or in combination with the other elements present in the reactor, namely the supporting elements and optionally the restrictions, a mean linear velocity of transit (also depending on the volume of gas to be treated) of the gaseous effluent to be purified in the reactor of between 0.05 and 10 m/s approximately, preferably between 0.1 and 3 m/s approximately. This velocity can be measured conventionally by means of any appropriate device well known to the person skilled in the art, such as an anemometer, placed, for example, close to the outlet of the reactor. The device of the invention may further comprise, preferably at or near the inlet of the photo-catalytic oxidation reactor, a filtering device for instance of the type HEPA commercially available from Honeywell.

The present invention also relates, in particular when intended for users who wish to assemble themselves a device for the purification of a gaseous effluent from its constituent elements, to a set of the components essential for the construction of a device as described above. This set will take, for example, the form of a kit of elements intended to constitute, by assembling, a device for the purification of a gaseous effluent comprising contaminants, said kit comprising:

a reactor comprising at least one inlet for the gas to be purified and at least one outlet for the purified gas,

at least one source of ultraviolet or visible radiation, and

at least one supporting element intended to be positioned inside the reactor and coated with a catalyst forming an exposed catalytic surface capable of at least partially oxidizing the contaminants under the action of ultraviolet or visible radiation supplied by the source,

said kit being characterized in that it comprises at least two blocking means intended to be positioned inside the reactor, each of said blocking means being intended to partially block the flow of the gaseous effluent from said inlet as far as said outlet and to generate a region of turbulent gas on its downstream side with respect to the flow of the gaseous effluent, the surface of each of said blocking means, as projected onto a plane orthogonal to the longitudinal axis of the reactor, occupying at least ⅓ (one third) of the internal cross section of the reactor available for the flow of the gaseous effluent, and in that a catalytic surface is positioned in each said region of turbulent gas so that the flow of turbulent gas is incident to said catalytic surface. Thus, such a kit generally comprises at least four elements (reactor, source and two blocking means, at least one of which is a supporting element), in addition to the means necessary for assembling them and the electrical connections necessary to provide power to the source. It can comprise a greater number of elements than four, in particular if there are more than two blocking means and/or the kit additionally comprises means for accentuating the turbulence as are defined above, such as forced ventilation or thermal convection means, and/or filtering means preferably located near the inlet of the reactor. In addition, the kit usually comprises a set of instructions for the benefit of the user to explain and facilitate the method for assembling the elements together. For reasons of convenience in assembling, it may be preferable, in the case of a kit, for the source to be intended to be placed outside the reactor. The reactor and the blocking means of the kit can comprise each of the more specific characteristics described above.

The technique used to deposit the photo-oxidation catalyst on the supporting element and, if appropriate, on the reflective surface of the device according to the invention is not a critical parameter of the present invention. Any known method for providing a lasting deposit, preferably of substantially homogeneous thickness, can be used in the context of the present invention. Non-limiting examples of such methods are well known to a person skilled in the art and include chemical vapor phase deposition, coating by centrifuging (also known under the tern of spin coating and consisting in covering the surface of a plate by making it rotate rapidly along an axis perpendicular to its surface and by allowing a drop of solution placed in its center to spread out) and dipping the supporting element (“dip coating”) into a catalytic suspension in an organic solvent, followed by a stage of drying at a temperature which does not result in a modification of the crystalline form of the catalyst, preferably at a temperature of between approximately 10° C. and 240° C. and more preferably between approximately 20° C. and 120° C., the duration of the drying naturally being, an inverse function of the drying temperature. In the dipping method, the dipping and drying cycle can be repeated as many times as necessary until the desired mass of catalyst per unit of surface area is obtained, i.e. typically between 0.5 g/m² and 15 g/m² approximately. The most appropriate deposition method will be chosen, in accordance with the general knowledge of a person skilled in the art, according in particular to the desired thickness of the catalyst layer. Usually, the deposition of a catalyst layer with a thickness of between 1 μm and 5 μm approximately is satisfactory to achieve the aims of the present invention. An optional improvement of the present invention consists in formulating the photocatalyst by means of mineral binders (such as colloidal silica) or organic binders (such as partially hydrolyzed alkyl silicates) in order to achieve a kind of sintering and consequently prevent or slow down any removal of catalyst particles during the process of treatment of the gaseous atmosphere under turbulent flow.

The nature of the photo-oxidation catalyst deposited on the supporting element of the device according to the invention and/or used in the process according to the invention is not a critical parameter of the present invention. Any catalyst of semiconductor type known for oxidizing, under the effect of ultraviolet or visible radiation, oxidizable entities present in the form of impurities in a gas can be used in the context of the present invention. The literature gives a great many examples of such catalysts, including titanium, silicon, tin and zirconium dioxide, zinc oxide, tungsten and molybdenum trioxides, vanadium oxide, silicon carbide, zinc and cadmium sulfides, cadmium selenide, their mixtures in all proportions and their solid solutions. These catalysts can additionally be doped by the addition of small proportions (that is to say, up to approximately 10% by weight) of other metals or of compounds of other metals, such as precious metals, in particular platinum, gold and palladium, or rare earth metals (such as niobium and ruthenium). If appropriate, the photooxidation catalyst can be deposited on a support, such as a zeolite, for example mordenite. In the case of titanium oxide, the catalyst can also be prepared, according to techniques well known to a person skilled in the art, in the form of an aerogel having a high specific surface. Because of the exceptional efficiency of the device according to the invention, it is not necessary, however, to use catalysts with a very high activity, which are complex to manufacture and/or which have a high cost price, and titanium dioxide in its anatase crystalline form is generally highly suitable.

According to another aspect, the invention also relates to a device for the purification of a gaseous effluent comprising contaminants, comprising:

a reactor comprising at least one inlet for the gas to be purified and at least one outlet for the purified gas,

at least one source of ultraviolet or visible radiation, and

at least one supporting element positioned inside the reactor and coated with a catalyst forming an exposed catalytic surface capable of at least partially oxidizing the contaminants under the action of ultraviolet or visible radiation supplied by the source, said supporting element acting as restriction to the flow of the gaseous effluent,

characterized in that the reactor is subjected to turbulent conditions of flow of the gaseous gaseous effluent to be purified defined by a turbulence index, calculated according to the formula I_{T}=Re*N/βf, in which

Re* is a number expressed by Re*=(4ρVₘS)/(Pν),

β=s/S is a porosity parameter, the value of which is equal to 1 if no restriction is present inside the reactor,

f is a friction factor corresponding to the ratio of the combined surface area in the reactor to the surface area developed by the reactor in the absence of restriction(s), equal to the sum of internal surface areas developed by the reactor/surface area of a cylinder with the perimeter P,

S is the mean surface area of the internal orthogonal cross section of the reactor in the absence of restriction(s),

ρ is the density of the gaseous effluent to be purified,

Vₘ is the mean velocity of the gaseous effluent to be purified parallel to the longitudinal axis of the reactor,

P is the sum of the mean internal perimeter of the reactor and of the mean external perimeter of the smaller geometric envelope comprising the radiation source(s), when the latter is (are) positioned inside the reactor,

ν is the dynamic viscosity of the gaseous effluent to be purified,

N is the number of restrictions in the reactor or else, in the absence of restriction, is equal to 1, and

s is the mean surface area of the opening defined by the internal orthogonal cross section of the reactor at the greatest extent of the restrictions,

at least equal to 2,000, preferably at least 50,000, more preferably at least 1,000,000.

Each of the terms used in the definition of this other aspect of the invention should be understood in agreement with explanations given in detail herein-above with respect to a preferred embodiment of the first aspect of the invention.

According to yet another aspect, the present invention also relates to a process for the purification of a gaseous effluent using a purification device as described in detail above. Such a device renders said process capable of purifying the gaseous effluent in an extremely efficient way, both with regard to the proportion of contaminants removed and with regard to the rate of removal. In the art, this efficiency can usually be expressed in terms of rate of oxidation of a predetermined proportion of a model impurity. Conventionally, the mean rate of oxidation of 90% of a model impurity consisting of acetone, as measured under the standardized conditions mentioned above, is chosen. This convention being chosen, it remains possible to choose the expression of the rate by reference to each parameter of the device and of the process according to the invention, namely the power of the source, the total catalytic surface area exposed, the mass of catalyst or the duration of exposure, or alternatively by reference to any combination of two or more of these parameters.

This method of expression of the efficiency means neither that the invention is limited to the purification of acetone nor that even higher rates than those mentioned hereinabove cannot be achieved, under the standard conditions mentioned above, for the purification of other organic compounds. A few values of the efficiency for other common organic compounds, such as ammonia, isopropanol or ethylamine, will be indicated hereinbelow.

With reference to a first method of expression of the efficiency, the invention makes it possible to achieve a mean rate of at least approximately 1 μmol of model impurity per hour, per watt of power of the source and per unit (gram per square meter) of surface density of the catalyst. This rate is preferably at least approximately 5 μmol of model impurity and can commonly reach up to approximately 50 μmol of model impurity per hour, per watt of power of the source and per unit (grain per square meter) of surface density of the catalyst. Rates (calculated at 90% oxidation) within a range from approximately 4 to approximately 60 μmol of impurity per hour, per watt of power of the source and per unit (gram per square meter) of surface density of the catalyst are commonly accessible for organic compounds such as ammonia, isopropanol or ethylamine.

With reference to a second method of expression of the efficiency, the invention makes it possible to achieve a mean rate of at least approximately 300 μmol of model impurity per hour, per watt of power of the source and per square meter of surface area of supporting element illuminated by the source. This rate is preferably at least approximately 500 μmol of model impurity and can commonly reach up to approximately 3000 μmol of model impurity per hour, per watt of power of the source and per square meter of surface area of supporting element illuminated by the source. Rates (calculated at 90% oxidation) which are much higher still, ranging from approximately 4 000 to more than 20,000 μmol of impurity per hour, per watt of power of the source and per square meter of surface area of supporting element illuminated by the source, are commonly accessible for organic compounds such as ammonia, isopropanol or ethylamine.

With reference to a third method of expression of the efficiency, the invention makes it possible to achieve a mean rate of at least approximately 100 μmol of model impurity per hour, per watt of power of the source and per gram of catalyst. This rate is preferably at least approximately 200 μmol of model impurity and can commonly reach up to approximately 2,500 μmol of model impurity per hour, per watt of power of the source and per gram of catalyst. Mean rates of photo-catalytic oxidation (calculated at 90% oxidation) which are much higher still, ranging from approximately 1,500 to approximately 4,000 μmol of impurity per hour, per watt of power of the source and per gram of catalyst, are accessible for organic compounds such as ammonia, isopropanol or ethylamine.

With reference to a fourth method of expression of the efficiency, the invention maltes it possible to achieve a mean rate of at least approximately 2 μmol of model impurity per hour and per watt of power of the source. This rate is preferably at least approximately 10 μmol of model impurity and can commonly reach up to approximately 70 μmol of model impurity per hour and per watt of power of the source. Rates (calculated at 90% oxidation) within a range from approximately 50 to approximately 400 μmol of impurity per hour and per watt of power of the source are commonly accessible for organic compounds such as ammonia, isopropanol or ethylamine.

The gas treated in the process according to the invention can be any gaseous effluent laden with contaminants and impurities from which it is desired to be freed, provided that this effluent comprises a proportion of oxygen sufficient to allow catalytic photooxidation to occur. A gaseous effluent which is preferred for the implementation of the invention is composed mainly of air. In the majority of cases, it is air polluted by gaseous or highly volatile contaminants. However, it can also be industrial gases other than air comprising, at a specific stage of an industrial process, undesirable impurities. If necessary, an appropriate amount of oxygen or of another oxidizing entity, such as ozone, can be injected into the gaseous effluent to be treated. Mention may be made, as non-limiting examples of contaminants which can be removed by virtue of the process according to the invention, of all kinds of volatile organic compounds, such as saturated aliphatic hydrocarbons (such as methane, propane, hexane, octane, and the like), unsaturated aliphatic hydrocarbons (such as ethylene, propylene, 1,3-butadiene and the like), light (i.e. having up to about 8 carbon atoms) aromatic hydrocarbons (such as benzene, toluene or xylenes), halogenated hydrocarbons (such as, for example, trichloroethylene), oxygen-comprising hydrocarbons (in particular alcohols, such as methanol, ethanol, isopropanol or butanol; ketones, such as acetone and hexanone; aldehydes, such as formaldehyde, acetaldehyde, propionaldehyde and butyraldehyde; ethers, such as diethyl ether; or phenols and chlorinated phenols), aminies (such as trimethylamine, ethylamine and pyridine), dioxins, triazines, polychlorinated biphenyls, cyanides or sulfur-comprising hydrocarbons (such as methyl mercaptan), and nonorganic compounds, such as ammonia, hydrogen sulfide, carbon monoxide, nitrated compounds (nitrogen oxides), sulfites, and the like, and mixtures of such compounds in all proportions.

The process according to the invention can be applied to the purification of contaminants in highly variable concentrations with respect to the gaseous effluent to be purified. For example, these concentrations vary within a range from approximately 0.001 to approximately 100,000 ppmv (parts per million by volume), preferably from 0.01 to 20,000 ppmv and more preferably still from 0.5 to 5,000 ppmv approximately. Furthermore, the process according to the invention can be applied within a wide range of temperatures (for example between about 0° and 70° C., preferably between 15° and 50° C.) and of pressures. The optimum temperature for implementing the process also depends on the saturated concentration of contaminant in the gaseous effluent to be treated, the relationship between these two parameters being well known to a person skilled in the art. As is obvious, the process according to the invention is preferably implemented at ambient temperature and at atmospheric pressure. The maximum temperature for carrying out the process will most often depend on the optimum operating temperature of the chosen source of ultraviolet or visible radiation.

The process according to the invention has numerous advantages (speed of purification, very satisfactory efficiency, even in the presence of ordinary and inexpensive catalysts, compact and modular device which is simple to manufacture, suitability for varied contaminants) which render it particularly suitable for the treatment of air in numerous environments, such as dwellings, vehicles for individual transportation by road (automobiles, trucks) or collective transportation by rail (trains, subway systems, streetcars) and in the air (planes), animal rearing, storage areas, or domestic and industrial cold stores, and for the treatment of gaseous effluents from chemical or biological reactors. In addition, it is fully compatible with other processes for the treatment of air, such as air conditioning (by heating or cooling), with which it can be combined in one and the same device.

In another embodiment, the invention relates to a process for preserving or controlling the quality of agricultural products in the gaseous atmosphere of a closed space or room, comprising subjecting said gaseous atmosphere to a photo-catalytic oxidation process according to a turbulent flow regimen. The said gaseous atmosphere usually contains one or more gaseous components, herein-after referred as contaminants, which accelerate the degradation of agricultural products, for instance the ripening of fruits and vegetables or the development of flowers and plants, and the contents of the contaminants in the gaseous atmosphere are reduced through the effect of photo-catalytic oxidation under turbulent regimen. These contaminants are usually from biological origin but may also have been inadvertently introduced into the closed space containing the agricultural products, for instance through the cigarette smoke of an employee of the storage or transportation company. Preferably, one of the contaminants is the ethylene biologically produced by the agricultural products, and its content is reduced below 1 ppm, preferably below 0.5 ppm, through the effect of photo-catalytic oxidation under turbulent regimen. In this embodiment, the process of the invention is preferably carried out by maintaining the gaseous atmosphere in the closed space or room at a temperature not exceeding 25° C, preferably not exceeding 18° C., and more preferably at a temperature selected within a range from 0 to 15° C. This temperature may usefully be adjusted as a function of the specific fruit or vegetable contained in the room and of the desired evolution stage (storage, transportation, or deliberate ripening) of this fruit or vegetable.

Advantageously with respect to the prior art, the process of this invention may be carried out by maintaining the gaseous atmosphere in the closed space or room at a temperature being from 0.5 to 5° C. higher than the temperature which would be necessary for obtaining the same ripening speed of the same fruit or vegetable in the absence of the said photo-catalytic oxidation process under turbulent regimen. This temperature difference makes it possible to calculate the achievable refrigeration savings, all other operating conditions (namely the final evolution stage of the fruit or vegetable) being otherwise equal.

Advantageously with respect to the prior art, the process of this invention may be carried out under variable pressures (preferably atmospheric pressure) and/or in a gaseous atmosphere having a variable oxygen content. This atmosphere may consist of air with a standard oxygen content (about 21% by volume) or in oxygen-depleted air, for instance having an oxygen content from about 1 to 18%, preferably from 2 to 10%, by volume. The latter embodiment may be especially advantageous when the closed space is a refrigerated transportation means (such as a charging box, a motor truck or a freight car) already equipped with a venting device through which the oxygen of air is partially replaced with an inert gas such as nitrogen. Preferably the turbulent flow regimen is characterized by the turbulence index previously described.

This embodiment of the process of the invention may further advantageously comprise a step in which the excess of carbon dioxide produced during the respiration of the agricultural products and/or the oxidation of ethylene is captured. This can be done in practice by providing, in the closed area containing the agricultural products, one or more reservoirs containing a solid substance which is highly reactive to carbon dioxide, such as chalk.

The process of the invention is broadly applicable to a wide range of agricultural products in which ethylene is involved in the ripening process, more particularly flowers, plants, vegetables and very many fruits such as apples, pears, bananas, avocados, grapes, kiwis, strawberries, prunes, nectarines, peaches, figs, litchis, mango's, pineapples, oranges, grapefruit, etc. Based on the type of fruit and the level to which it has advanced in the distribution chain from harvester to final consumer, the working temperature of the process of the invention and the level of oxygen in the gaseous atmosphere to be treated can be adjusted, for instance by reference to the recommended conditions published on the internet site http://postharvest.ucdavis.edu.

The process for the preservation of agricultural products according to the invention presents numerous advantages, such as:

the possibility to remove at least 90% of the ethylene present in the closed area containing the agricultural products, at an industrially relevant speed, in the order of 0.1 to 1.5 μmoles per hour per watt of the power source and per unit (gram per square meter) of surface density of the catalyst, even when the initial ethylene concentration is very low (in the order of magnitude of 5 to 50 ppm),

due to the rapid removal of ethylene produced by the ripening and/or the development of the agricultural products, the preservation of their freshness (flowers and plants) or of their organoleptic properties (fruits and vegetables),

a reduction of the consummation of energy, at a steady rate, during transport or cooled storage of agricultural products.

Another advantage of this embodiment of the process according to the invention resides in the use of photo-catalytic reactors of a much reduced size and weight than those used in the absence of a turbulent flow regimen, which makes that a lesser volume is taken away from the volume available for the storage of the agricultural products.

The present invention is now illustrated by means of the following non-limiting examples.

### EXAMPLE 1

Preparation of the Photocatalytic Support

5 g of titanium dioxide (available commercially under the reference P25 from Degussa and comprising approximately 20% of rutile and 80% of anatase) or, as specified in each example hereinbelow, of another photooxidation catalyst based on semiconducting oxide(s) is suspended in 500 ml of alcohol using an ultrasonic bath from Bransonic with a power of 130 W for a capacity of 5.5 liters. The suspension obtained, which is stable over a period of several weeks, is subsequently used for the coating of catalyst supporting elements of various natures and numbers, for example made of aluminum or of paper. These elements can be longitudinal fins according to the prior art (example 8) or else rings according to the invention (other examples). The coating is carried out by rapidly dipping the supporting element, under ultrasound, in the catalyst suspension and by then drying it at a temperature of approximately 70° C. The dipping and drying cycle is repeated until the desired mass of catalyst is obtained.

### EXAMPLE 2

First Embodiment of the Device According to the Invention

This first embodiment is described with reference to the representation in perspective of FIG. 1. Rings (2) with an external diameter of 35 mm comprising a circular opening (3) with a diameter of 15 mm at their center are first obtained by cutting out either aluminum sheets with a thickness of 100 μm degreased with methanol or filter papers (Whatman No. 5) and are then coated with catalyst in accordance with the method of example 1.

A cylindrical glass reactor (1) with a length of 25 cm and an internal diameter of 4 cm is equipped with rings (2)—six of which are represented in FIG. 1—acting as catalytic supports, placed along a source (4) composed of a fluorescent tube (UV A Cleo 15 watts, sold by Philips) with a diameter of 15 mm and separated from one another by approximately 12 mm. A reflector (5) can be installed against the internal wall of the reactor (1). A fan (6) and a filter (7) are placed at the ends of the reactor (1).

### EXAMPLE 3

Second Embodiment of the Device According to the Invention

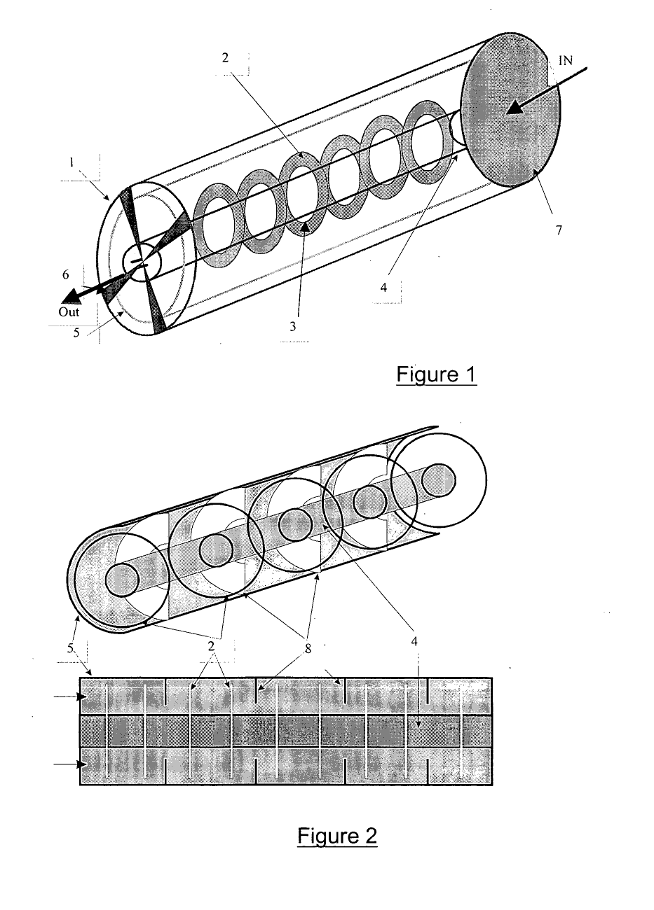

This second embodiment is described with reference to FIG. 2, which gives a representation in perspective (top view) and a longitudinal section (bottom view) of it. It comprises, in addition to the elements already present in FIG. 1, indicated by the same numbers and with the same dimensions as in example 2, baffles (8) formed of rings with an external diameter of 4 cm for an internal opening with a diameter of 2 cm. These baffles (blocking means) are inserted every two rings (2) and are in direct contact with the wall of the reactor (1). A fan (6) and a filter (7) (not represented in FIG. 2) can be placed at the ends of the reactor (1) as in example 2.

### EXAMPLE 4

(Comparative)—Device According to the Prior Art

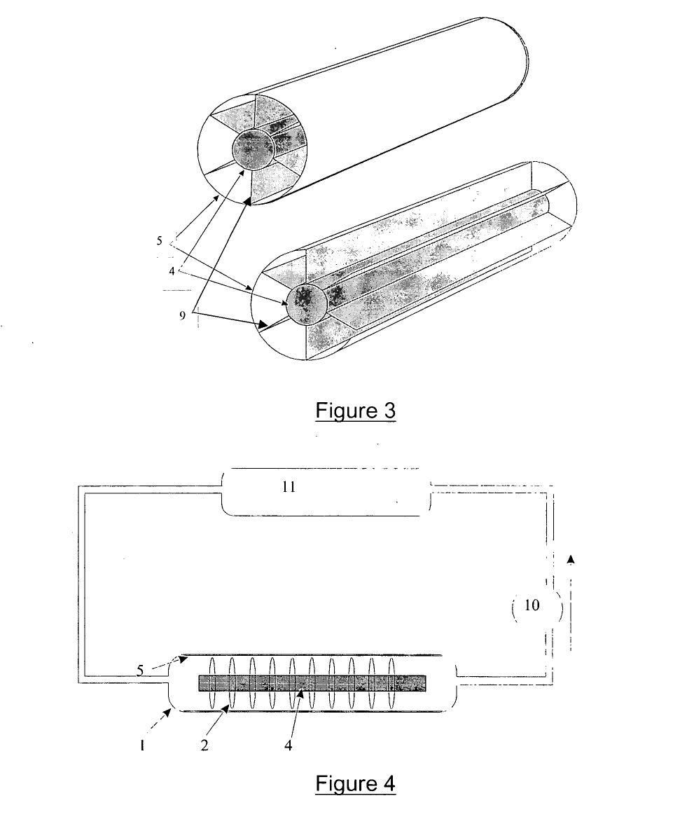

A reactor with the same external dimensions as that of examples 2 and 3 and in accordance with U.S. Pat. No. 5,790,934 is described with reference to FIG. 3, which gives a representation in perspective with transverse section (top view) and a representation in open perspective (bottom view) of it. Comprising the elements already present in FIG. 1 and represented by the same numbers, it is obtained by replacing the rings (2) with six equidistant (that is to say, forming an angle of 60 degrees with one another) longitudinal fins (9) positioned radially with respect to the tube (4) and occupying the entire space between the tube (4) and the reflector (5) applied against the internal face of the reactor (1). A fan (6) and a filter (7) (not represented in FIG. 3) can be placed at the ends of the reactor (1) as in example 2.

### EXAMPLE 5

Purification From Acetone—Comparison with the Prior Art

The efficiency of the present invention for the purification from acetone is compared with that of the technique disclosed in patent application WO 99/24277. To this end, a closed-circuit experimental assembly, represented in FIG. 4, similar to that of FIG. 1 of said prior document and comprising a device analogous to the embodiment of example 2, is prepared. For this reason, the reference numbers in FIG. 4 denote the same elements as in FIG. 1, namely the reactor (1), the rings (2), the fluorescent source (4) and the reflector (5). This device is in a circuit with a pump (10) and a gas bulb (11). The acetone is injected into the bulb (11), where it is vaporized before being brought into the presence of the catalyst. The flow rate for circulating the gas is approximately 0.5 liter per minute. In this assembly, 10 rings of filter paper (Whatman No. 5) coated with catalyst in accordance with the method of example 1 are used. However, the catalyst used is not titanium dioxide P25 but a sol-gel TiO₂ prepared in the following way: 11 ml of alcohol and then 12.5 ml of water are gradually added to 9 ml of titanium tetraethoxide Ti(OC₂H₅)₄ from Aldrich in a glass container and with magnetic stirring. Stirring is maintained for an hour, after which the product is matured at 70° C. for 17 hours. Subsequently, a calcination at 400° C. for 2 hours makes it possible to obtain 3 grains of anatase powder which is lightly milled before being placed on the support.

As in the procedure of the prior document:

the initial concentration of acetone is equal to approximately 77,000 ppmv (parts per million by volume),

the system is first stabilized for 10 hours with the UV source extinguished, which makes it possible to observe (see table 1 hereinbelow) a strong absorption of the acetone on the catalyst and the various internal surfaces of the device before reaction.

When the system is equilibrated, the source is switched on and samples are withdrawn at regular intervals and analyzed by gas chromatography coupled to a mass spectrometer in order to monitor the change in the removal of the acetone and the production of byproducts in trace amounts (acetaldehyde and formaldehyde) and of the mineralization products (CO₂ and H₂O).

The operating conditions and the results obtained, described in the prior document (pages 13 to 22, FIG. 15B for the anatase, FIG. 17A for the aerogel), on the one hand, and observed in the present example, on the other hand, are summarized in table 1 hereinbelow. From the point at which photocatalytic oxidation begins under the action of ultraviolet radiation (t=10 hours), it is observed that the time necessary for the disappearance of 90% of the acetone is 90 minutes according to the invention and 15 hours on employing the aerogel of patent application WO 99/24277, while only approximately 85% of the acetone disappeared after 30 hours on employing the anatase of the same prior document. Taking into account the amount of catalyst and the illuminating power involved, the rate of oxidation made possible by the example according to the invention is still, whatever the method of expression of this rate, at least 17 times greater than that demonstrated by the state of the art.

TABLE 1

| | WO 99/24277 | WO 99/24277 | Example 5 |
|---|---|---|---|
| Type of titanium dioxide | anatase | aerogel | anatase |
| | | | (sol-gel) |
| Mass (g) of catalyst | 3.4 | 1.33 | 0.060 |
| Specific surface (m²/g) of | 80 | 423 | 150 |
| the catalyst | | | |
| Surface area illuminated | 48.5 | 26.6 | 157 |
| (cm²) | | | |
| Power of UV source (W) | 300 | 300 | 15 |
| Volume of the system (ml) | 300 | 300 | 600 |
| Acetone initial volume (ml) | 0.075 | 0.075 | 0.140 |
| Concentrations of acetone | | | |
| (μmol/l) | | | |
| initial | 3,000 | 3,000 | 3,200 |
| after 10 hours | 2,400 | 240 | 320 |
| after 11.5 hours | 2,130 | 216 | 32 |
| after 25 hours | 780 | 24 | n.d. |
| after 40 hours | 350 | 10 | n.d. |
| Rate at 90% oxidation | | | |
| in μmol/h/W/g | 0.067(*) | 0.036 | 213 |
| in μmol/h/W/m² | 47(*) | 18 | 815 |
| in μmol/h/W/g/m² | 13.8(*) | 13.6 | 13,600 |
| in μmol · cm²/h/W/g | 3.3(*) | 0.96 | 33,500 |
| in μmol/h/W | 0.228(*) | 0.048 | 12.8 |

n.d.: not detectable
(*)rate at 85% oxidation after illuminating for 30 h

### EXAMPLE 6

Comparison of the Operation of a Reactor With and Without Internal Optical Reflector

Two configurations A and B of a reactor in accordance with the first embodiment of the invention (example 2, FIG. 1) are evaluated in a hermetically sealed parallelepipedal chamber with dimensions of 1 m □ 1 m □ 0.6 m, covered with sheets of poly(vinyl fluoride) Tedlar in order to limit the adsorption on the walls, with a free internal volume of 450 liters. In each alternative form, the reactor is equipped with 15 aluminum rings covered with TiO₂ (18 mg in total) in accordance with example 1, the rings being separated by approximately 1.5 cm. In the configuration A, the reactor (1) does not comprise a reflector. In the configuration B, the reactor (1) comprises an aluminum reflector (5) with a thickness of 100 μm placed against its internal wall. Each reactor configuration is placed in turn in the sealed chamber of 450 liters and is connected to a first fan which makes it possible to recycle the air in the chamber several times through the photocatalysis region. 0.65 g of acetone (corresponding to an initial concentration of 555 ppmv) is poured into the chamber and homogenized by means of a second fan. The source (4) is switched on when the concentration of acetone in the chamber is stabilized, i.e. approximately 15 minutes after the introduction of the acetone. The mean linear velocity of the air in the reactor is 1.1 m/s, i.e. a mean residence time of 0.22 s. Taking into account a dynamic viscosity of 0.000018 Pa.s and a density of the air of 1.2 kg/m³, it is easy to calculate that the turbulence index, defined by the formula I_{T}=Re*□ N/(□ □ f), of the configurations A and B of the reactor is equal to 96,775 (to this end, it will first be confirmed that Re*=2,719, □=0.27 and □=1.55).

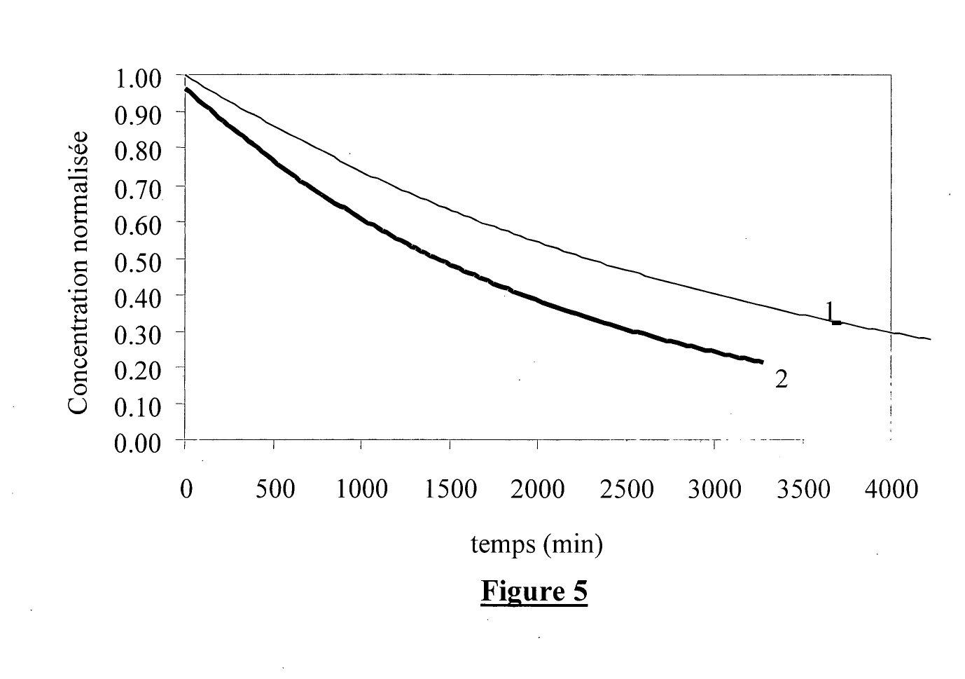

A change in the system is monitored using a Quad gas chromatograph from Agilent operating simultaneously on three columns (an OV1 column to monitor the acetone, a 5 angstrom molecular sieve to monitor the oxygen and a PPQ column for the detection of the carbon dioxide gas) and the standardized concentration of acetone is represented in FIG. 5. It is thus observed that 50% of the acetone has disappeared after 1,400 minutes for the reactor with the reflector (curve 2) and only after 2,250 minutes for the reactor without reflector (curve 1). The rate of disappearance of the acetone at the start, on the one hand, and after 50% oxidation, on the other hand, expressed under standard conditions, is indicated in table 2 hereinbelow according to various methods of expression.

TABLE 2

| Configuration | A | B |
|---|---|---|
| Initial rate | | |
| in μmol/h/ W/g | 765 | 3,440 |
| in μmol/h/W/m² | 585 | 2,630 |
| in μmol · m²/h/W/g | 18 | 81 |
| in μmol/h/W | 14 | 62 |
| Rate at 50% oxidation | | |
| in μmol/h/W/g | 550 | 890 |
| in μmol/h/W/m² | 420 | 680 |
| in μmol · m²/h/W/g | 13 | 21 |
| in μmol/h/W | 10 | 16 |

### EXAMPLE 7

Reduction in the Acetone in a Sealed Chamber—Influence of the Residence Time

A reactor with a configuration similar to that of the first embodiment of the invention (example 2, FIG. 1) but with different dimensions is placed in the same chamber of 450 liters as in example 6 but using 2.7 g of acetone (thus an initial concentration of 2,300 ppmv). This tubular aluminum reactor, the internal face of which exhibits good reflectivity to light, has an internal diameter of 13 cm and a length of 90 cm. Two fluorescent tubes, each of 20 W, are positioned axially behind one another. 20 paper rings with an external diameter of 11 cm, pierced at their center with the dimension (26 mm) of the fluorescent tubes and separated by 4.5 cm, are coated with TiO₂ in accordance with the method of example 1 and support a total weight of catalyst of 1.3 g. The mean velocity of the gases is 1.5 m/s, i.e. a mean residence time of 0.6 s. Under these conditions, it is easy to calculate that the turbulence index, defined by the formula I_{T}=Re*βN/(β×f), of this configuration of the reactor is equal to 474,758 (to this end, it will first be confirmed that Re*=12,737, β=0.3 and f=1.81).

For the record, the complete mineralization of acetone corresponds to the following equation:

CH₃COCH₃+4O₂3CO₂+3H₂O→

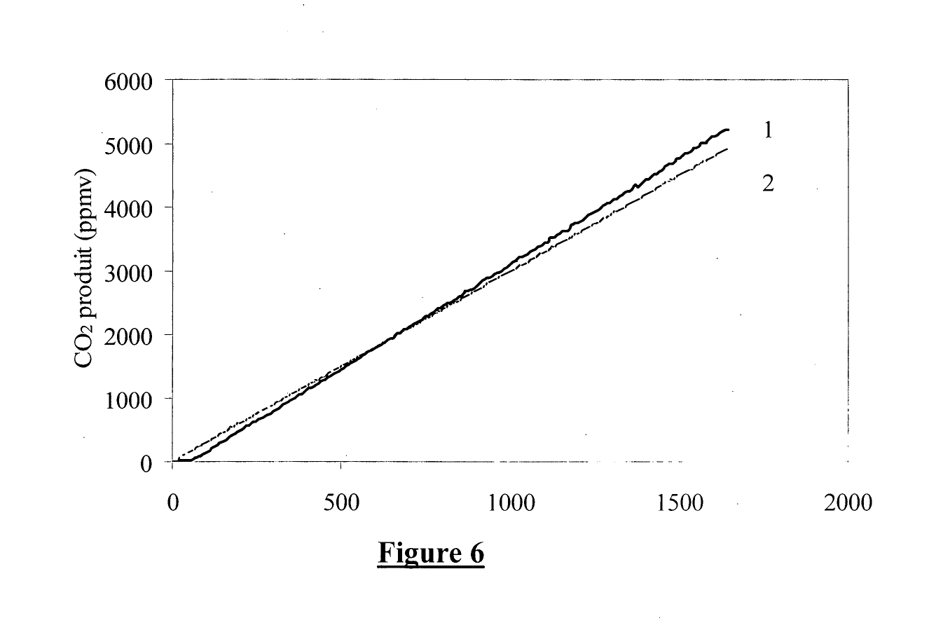

FIG. 6 exhibits the experimental change (curve 1) in CO₂ produced (expressed in ppm v) as a function of the acetone consumed (also expressed in ppmv) in comparison with the theoretical change (curve 2) resulting from this equation and thus shows complete mineralization of the acetone. The production of CO₂, slightly greater than the theoretical value at the end of the experiment, is explained by the presence of paper rings which decompose slightly on contact with TiO₂. This example illustrates that the complete mineralization of the acetone is possible with a sufficiently long residence time in the reactor.

### EXAMPLE 8

(Comparative)—Purification from Acetone Accord in to the Prior Art

Use is made of a reactor in accordance with example 4, having six fins each having a length of 25 cm (i.e. the total length of the reactor) and a width of 1.25 cm, the entire internal surface area (active surface area exposed to the radiation: 765 cm²) of which is covered with titanium dioxide (total quantity: 100 mg), and equipped with a fan. This reactor is placed in the chamber of 450 liters of example 6 and started under the following conditions:

amount of acetone: 2.6 g (initial concentration of 2,220 ppmv)

velocity of the gas: 1.2 m/s.

Under these conditions, it is easy to calculate that the turbulence index, defined by the formula I_{T}=Re*βN/(β×f), of this configuration of the reactor is equal to 1,588 (to this end, it will first be confirmed that Re*=2,966 and f=1.87 and it is considered that N=1 and β=1, that is to say the fins do not result in a significant reduction in the surface area perpendicular to the flow).

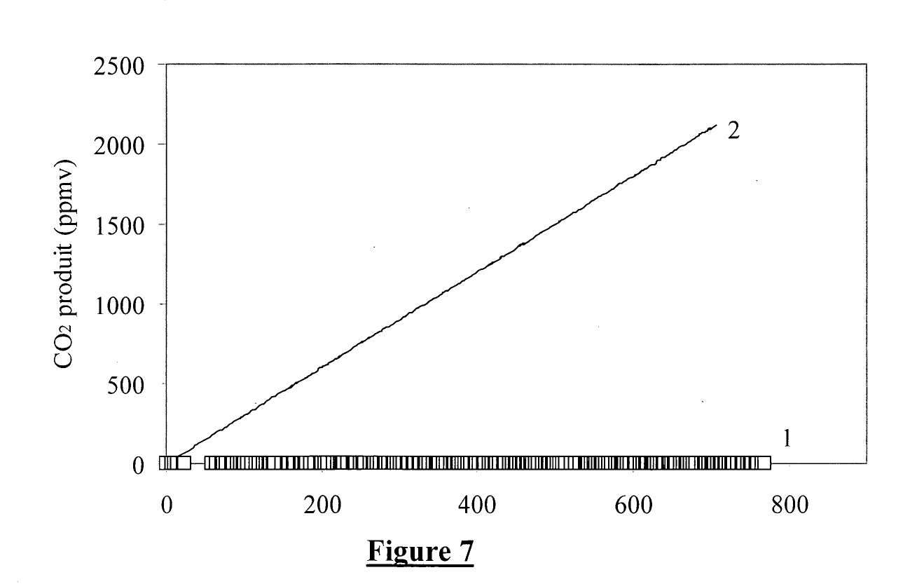

FIG. 7 exhibits the experimental change (curve 1) in CO₂ produced (expressed in ppmv) as a function of the acetone consumed (also expressed in ppmv) in comparison with the theoretical production (curve 2) corresponding to complete mineralization according to the abovementioned equation. It thus shows that, in contrast to the device according to the invention (example 7), the reactor with fins is completely inactive with respect to the mineralization of the acetone. In all probability, the acetone is then simply decomposed to formaldehyde and acetaldehyde or else remains attached to the catalyst.

### EXAMPLE 9

Influence of Photocatalyst on the Reflective Surface

A reactor in accordance with the configuration B of example 6 is studied under the conditions of this example (0.65 g of acetone in 450 liters of air, i.e. an initial concentration of 555 ppmv), the mean residence time of the gas in the reactor being 0.18 s. However, unlike example 6, the reflector of this reactor was covered with a very fine layer of TiO₂, corresponding to 3 mg per 315 cm² of reflector.

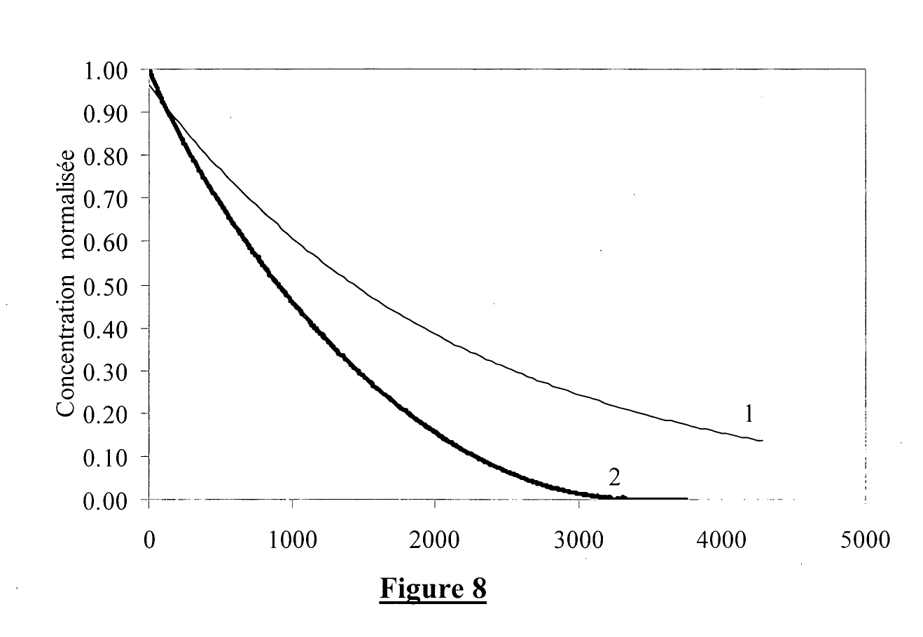

FIG. 8 exhibits the change in the decomposition of the acetone (expressed as standardized concentration, that is to say as relative concentration with respect to the initial concentration) as a function of time for the reflector uncoated with catalyst (curve 1, already presented in FIG. 5) by comparison with the reflector coated with catalyst (curve 2). A spectacular improvement in the performance of the reactor is observed, since complete removal of the acetone is obtained after 3,200 minutes and since removal of 80% of the acetone is obtained after 1,800 minutes in the presence of catalyst on the reflector (instead of 3,400 minutes in the absence of catalyst on the reflector). Furthermore, no trace of intermediate product is detectable in the gas phase when all the acetone is consumed, indicating complete mineralization of this compound.

The rate of disappearance of the acetone at the start, on the one hand, and after 80% oxidation, on the other hand, expressed under standard conditions, is indicated in table 3 hereinbelow according to the various methods of expression already used above.

These results show that the reflector coated with a very fine layer of catalyst, making possible multiple reflections for each ray, increases the active surface area exposed to the radiation and results in virtually complete use of the light radiation, thus optimizing the use of the light energy emitted by the fluorescent tube and the excitation of the photocatalyst.

TABLE 3

| Reflector | Uncoated | Coated |
|---|---|---|
| Initial rate | | |
| in μmol/h/W/g | 3,440 | 1,970 |
| in μmol/h/W/m² | 2,630 | 750 |
| in μmol · m²/h/W/g | 81 | 108 |
| in μmol/h/W | 62 | 41 |
| Rate at 80% oxidation | | |
| in μmol/h/W/g | 590 | 950 |
| in μmol/h/W/m² | 450 | 845 |
| in μmol · m/h/W/g | 14 | 22 |
| in μmol/h/W | 10.6 | 20 |

### EXAMPLE 10

Influence of the Presence of Additional Restrictions in the Reactor for the Decomposition of Acetone

A reactor in accordance with the second embodiment of the invention (example 3, FIG. 2), having 15 rings coated with 18 mg of TiO₂, is installed in the chamber of 450 liters of example 6 and is started with an amount of acetone of 0.66 g and a mean residence time of 0.62 s. The walls and the baffles of this reactor are made of reflective material but are not 10 covered with TiO₂.

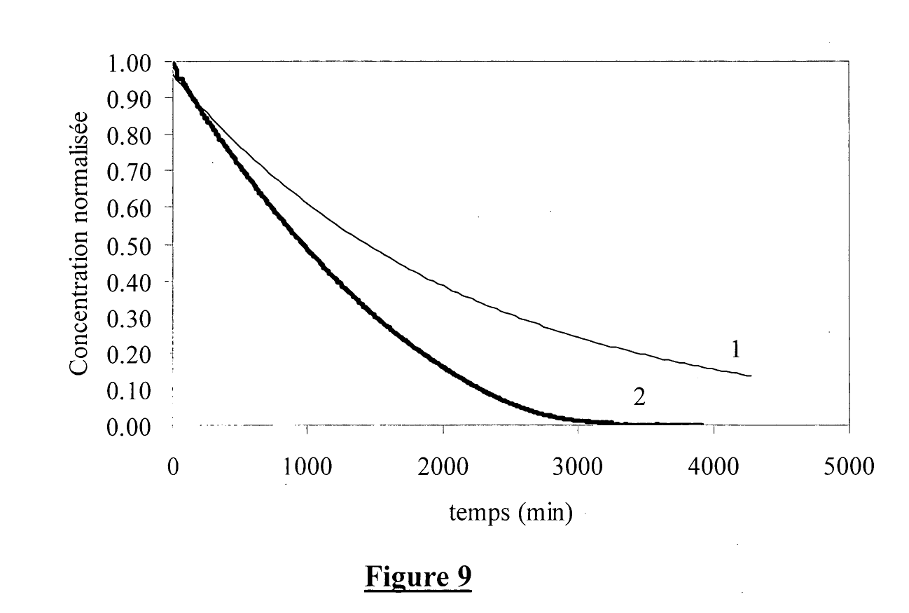

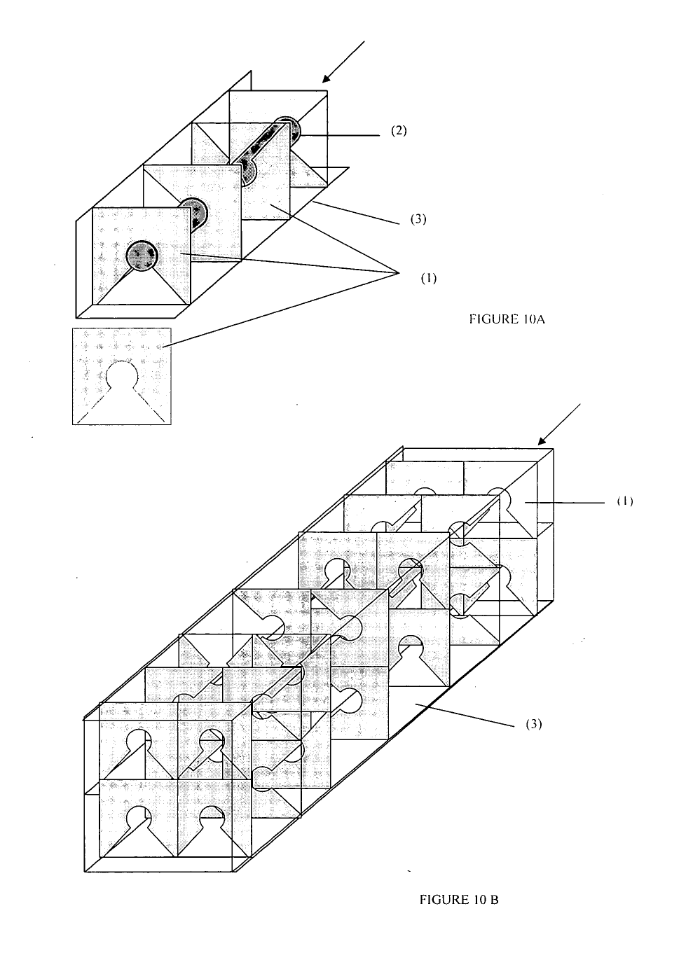

FIG. 9 exhibits the change in the decomposition of the acetone (expressed as standardized concentration) as a function of time (curve 2), compared with that of example 6 (curve 1). The performance of the reactor is spectacularly improved since complete removal of the acetone is obtained after 3,300 minutes and since removal of 80% of the acetone is obtained after only 1,850 minutes in the presence of baffles (instead of 3,400 minutes in the absence of baffles). The rate of disappearance of the acetone at the start, on the one hand, and after 80% oxidation (without baffles) or else 90% oxidation (with baffles), on the other hand, expressed under standard conditions, is indicated in table 4 hereinbelow according to various methods of expression.

TABLE 4

| Configuration | With baffles | Without baffles |
|---|---|---|
| Initial rate | | |
| in μmol/h/W/g | 1,530 | 3,440 |
| in μmol/h/W/m² | 1,170 | 2,630 |
| in μmol · m²/h/W/g | 36 | 81 |
| in μmol/h/W | 28 | 62 |
| Rate at 90% oxidation | | |
| in μmol/h/W/g | 1,000 | 600(*) |
| in μmol/h/W/m² | 765 | 457(*) |
| in μmol · m^{2/h/W/g} | 24 | 14(*) |
| in μmol/h/W | 18 | 11(*) |

(*)rate at 80% oxidation after illuminating for 3,400 minutes.

### EXAMPLES 11 and 12

Decomposition of Ammonia

The photocatalytic decomposition of ammonia (as air pollutant) is carried out in a reactor in accordance with the first embodiment of the invention (example 2, FIG. 1) and by using the assembly of figure (i.e. a volume of 0.6 l). The number N of rings, the initial amount of pollutant (expressed in μmol) and the total mass of the catalyst deposited on the rings (expressed in mg) are mentioned in table 5 hereinbelow. The results of these experiments, namely the time t (expressed in minutes) after which the amount of pollutant has been reduced by 90% under the standard conditions, from which the various methods of expression of the rate with which 90% of the pollutant has been decomposed are calculated, are shown in the same table. The catalyst used in example 11 is the titanium dioxide P25 of example 1. The catalyst used in example 12 is the sol-gel TiO₂ of example 5. These examples show that ammonia can be purified from the air by employing a very small amount of catalyst and with rates much greater than those observed for acetone.

### EXAMPLES 13 and 14

Decomposition of Isopropanol

The photocatalytic decomposition of isopropanol (as an air pollutant) is carried out in a reactor in accordance with the first embodiment of the invention (example 2, FIG. 1) and by using the assembly of FIG. 4, the catalyst used being the titanium dioxide P25 of example 1 and the number N of rings and the catalytic mass being varied. The results of these experiments are shown in table 5 hereinbelow and show that isopropanol can be purified from the air by employing very small amounts of catalyst and with rates much greater than those observed for acetone.

### EXAMPLES 15 and 16

Decomposition of Ethylamine under the Effect of Visible Radiation

The photocatalytic decomposition of ethylamine (as an air pollutant) is carried out in a reactor in accordance with the first embodiment of the invention (example 2, FIG. 1) and by using the assembly of FIG. 4, with the exception of the fact that the UV fluorescent tube is replaced by a source with a power of 8 watts emitting visible light sold by Sylvania under the reference 133. The catalyst used in example 15 is the titanium dioxide P25 of example 1. The catalyst used in example 16 is the sol-gel TiO₂ of example 5. The results of these experiments are shown in table 5 hereinbelow and show that ethylamine can be purified from the air under the effect of visible radiation by employing very small amounts of catalyst and with rates much greater than those observed for acetone.

TABLE 5

| Example | 11 | 12 | 13 | 14 | 15 | 16 |
|---|---|---|---|---|---|---|
| Pollutant | 2,230 | 705 | 1,290 | 1,290 | 1,770 | 885 |
| (μmol) | | | | | | |
| N rings | 10 | 10 | 6 | 12 | 10 | 10 |
| Catalyst (mg) | 133 | 50 | 12 | 60 | 60 | 65 |
| t_{90%} (minutes) | 25 | 20 | 100 | 35 | 120 | 30 |
| Rate (90%) | | | | | | |
| μmol/h/W/g | 2,415 | 2,538 | 3,870 | 2,210 | 1,660 | 3,060 |
| μmol/h/W/m² | 20,070 | 7,930 | 4,840 | 6,910 | 6,220 | 12,400 |
| μmol/h/W/g/m² | 150,900 | 158,600 | 403,000 | 115,000 | 103,700 | 191,500 |
| μmol.m²/h/W/g | 39 | 41 | 37 | 42 | 27 | 49 |
| μmol/h/W | 357 | 141 | 52 | 148 | 111 | 221 |

### EXAMPLES 17 to 20

Decomposition of Acetone at High Concentration

The photocatalytic decomposition of 1,380 μmol of acetone as air pollutant is carried out in a reactor in accordance with the first embodiment of the invention (example 2, FIG. 1) and by using the assembly of FIG. 4 (that is to say, a volume of 0.6 liter, thus an initial concentration of acetone of 50,000 ppmv), the catalyst used being the titanium dioxide P25 of example 1 (for examples 17 and 18) or else the sol-gel TiO₂ of example 5 (for examples 19 and 20) and the number N of rings and the catalytic mass being varied. The results of these experiments are shown in table 6 hereinbelow.

### EXAMPLES 21 and 22

Decomposition of Acetone at Moderate Concentration

The photocatalytic decomposition of 11,190 μmol of acetone as air pollutant is carried out in a reactor in accordance with the first embodiment of the invention (example 2, FIG. 1) comprising 15 rings (supporting 18 mg of catalyst in total) and a reflector covered with catalyst, providing a surface area exposed to the light of 550 cm². This reactor is placed in the chamber of 450 liters of example 6 (thus the initial concentration of acetone is 555 ppmv), the catalyst used being the titanium dioxide P25 of example 1. The amount of catalyst covering the reflector is 3 mg in example 21 and 250 mg in example 22. The results of these experiments are shown in table 6 hereinbelow.

TABLE 6

| Example | 17 | 18 | 19 | 20 | 21 | 22 |
|---|---|---|---|---|---|---|
| N rings | 6 | 11 | 6 | 18 | 15 | 15 |
| Catalyst (mg) | 17 | 60 | 12 | 108 | 21 | 268 |
| t_{90%} (minutes) | 250 | 110 | 200 | 80 | 2,300 | 1,250 |
| Rate (90%) | | | | | | |
| μmol/h/W/g | 1,170 | 750 | 2,070 | 575 | 835 | 120 |
| μmol/h/W/m² | 2,070 | 2,560 | 2,590 | 2,150 | 318 | 585 |
| μmol/h/W/g/m² | 121,700 | 42,700 | 215,600 | 20,000 | 15,200 | 2,200 |
| μmol.m²/h/W/g | 11.2 | 13.2 | 20 | 16.6 | 46 | 6.6 |
| μmol/h/W | 22 | 50 | 28 | 69 | 19 | 36 |

### EXAMPLE 23

Reactor with a Reflective Internal Wall Covered with Catalyst

The reactor is composed of the combination (represented in FIG. 10B, with the exception of the UV-A lamps) of four modules(each in accordance with the representation in FIG. 10A) inserted in a parallelepipedal tube (not shown in FIG. 10) equipped with a fan (not shown in FIG. 10) at its exit end. Each module comprises 16 restrictions (only four of which are represented in FIG. 10A, and seven of which are represented in FIG. 10B), each restriction (1) forming, with the adjacent restriction, an angle of rotation of 90 degrees, and is equipped with a UV-A lamp (2) with a power of 15 W. Each restriction (1), with a shape illustrated in detail in FIG. 10A, occupies three quarters of the transverse cross section of the reactor and allows the lamp (2) to pass though its center. All the internal surfaces—wall (3) of the reactor and restrictions (1)—of the reactor have been covered by spraying with a mass of TiO₂ of 2.0 g per total surface area of 5,620 cm², the dimensions of each module being5×5×26cm.

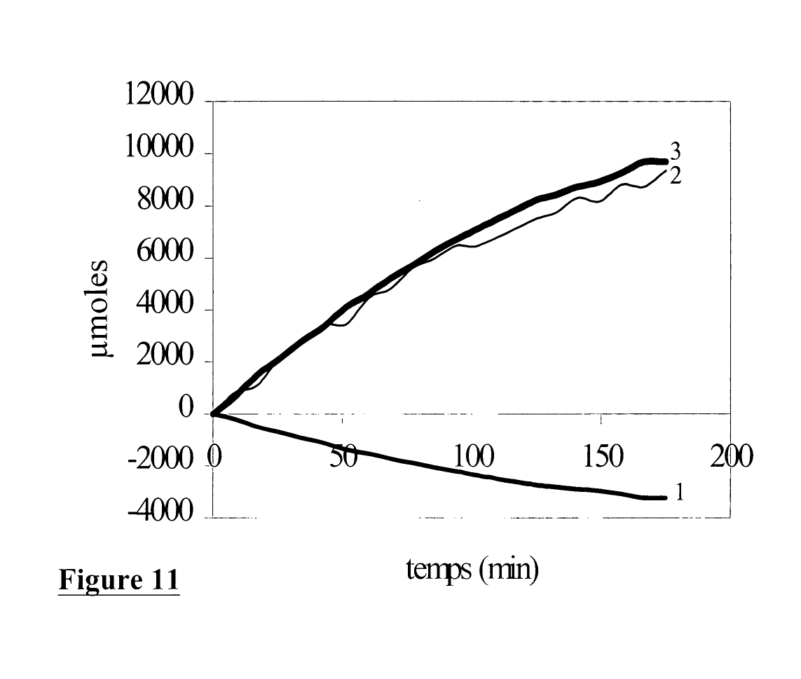

The operation of this reactor for the decomposition of acetone was studied with a gas flow rate through the reactor of 27 m³/h, the reactor being provided with a fan and placed in a tight chamber made of poly(methylmethacrylate) with a volume of 950 liters. 3,390 μmol of acetone are introduced at the inlet of the reactor. After a period of 15 minutes, making it possible to stabilize the concentration of acetone at a constant level, the UV-A lamps are switched on. The decomposition of the acetone and the production of the decomposition products (experimental CO₂) are monitored by gas chromatography (Quadh gas microchromatograph from Agilent) and are represented in FIG. 11, as is the theoretical value of CO₂ as a function of acetone which has disappeared. FIG. 11 clearly illustrates, by comparison between the theoretical value and the experimental value for CO₂, that the mineralization of the acetone is complete, the only reaction products being CO₂ and H₂O. The rate of oxidation calculated is equal to 17 μmol.m²/h/g/W.

This indicates a very efficient use of the light energy in a reactor with a reflective internal wall covered with catalyst.

### EXAMPLE 24

Other Forms of Construction of the Device

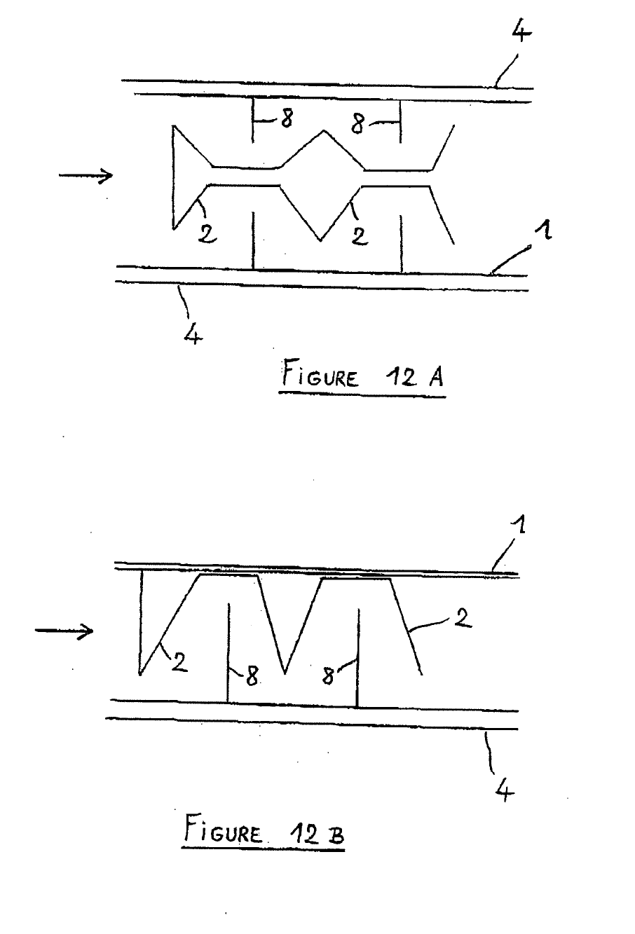

Two other forms of construction (among innumerable possibilities) A and B of the device according to the invention are represented in longitudinal section in FIG. 12, comprising a reactor (1) with a longitudinal axis, one or more catalyst supporting elements (2) which block the gas flow, at least one blocking means (8) and a light source (4), for example a cylindrical source, placed outside the reactor, the direction of the gas flow being indicated by an arrow on the left-hand side of the figure.

### EXAMPLE 25

Degradation of Toluene by Means of a Photo-Catalytic Reactor under Turbulent Flow

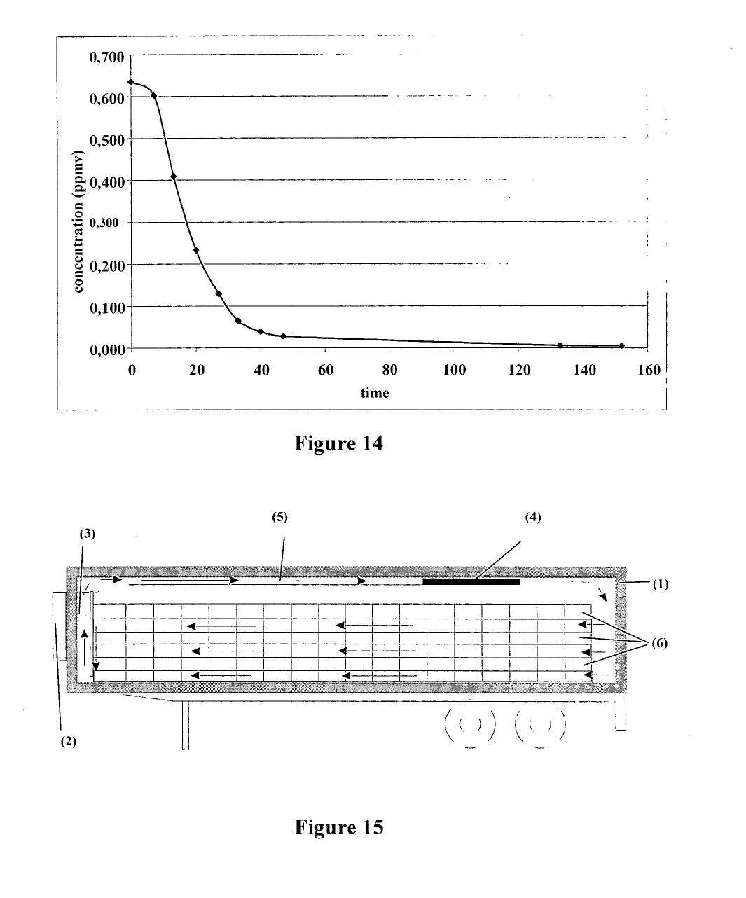

The kinetics of oxidative degradation of toluene was studied while using the same reactor and the same tight chamber as disclosed in example 23, but injecting 2.5 μmole toluene into the chamber by means of a syringe. Thus the initial toluene concentration in the chamber was 0.640 ppmv. The photo-catalytic reactor is then activated by means of the UV-A lamps and the toluene concentration is measured and recorded by means of the gas microchromatograph. Results of the experiment are shown in FIG. 14. Toluene concentration decreases to 0.065 ppmv after 33 minutes, 0.039 ppmv after 40 minutes and 0.006 ppmv after 133 minutes. These data correspond to a rate (calculated at 90% oxidation) of 0.39 μmole of toluene per hour, per watt of power of the source and per unit (gram per square meter) of surface density of the catalyst.

### EXAMPLE 26

Refrigerated Trailer Equipped with a Device for the Preservation of Fruits

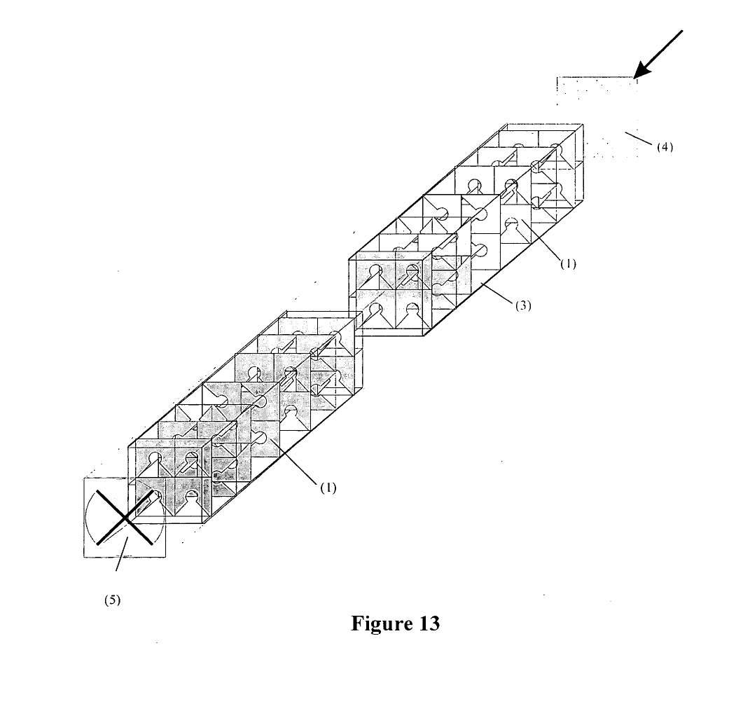

FIG. 15 schematically shows a view of a refrigerated trailer (1) wherein the circulation of refrigerated air or oxygen-depleted air is obtained by means of a cooling system (2) coupled with a fan (3). Refrigerated air or oxygen-depleted air is then forced to be conveyed by means of a throat (5) in the direction of a photo-catalytic reactor (4) which may be for instance of the type shown in FIGS. 10 or 13. The trailer is equipped with a series of racks or shelves (6) wherein fruits or vegetables may be carefully stored. Space between two adjacent racks or shelves (6) is left free for the circulation of refrigerated air or oxygen-depleted air (the direction of circulation being shown by means of arrows).

### EXAMPLE 27

Degradation of Ethylene by Means of a Photo-Catalytic Reactor under Turbulent Flow

The kinetics of oxidative degradation of ethylene was studied at 20° C. under atmospheric pressure while using the same tight chamber (volume 950 l) as disclosed in example 23 and the photo-catalytic reactor shown in FIG. 13. The latter, similar to that shown in FIG. 10B, comprises two sets of 4 photo-catalytic modules enclosed within the reactor wall (3) and, in addition, includes a filter (HEPA type available from Honeywell) (4) at the inlet and a fan (5) at the outlet. Each photo-catalytic module is in accordance with FIG. 10A and has 16 restrictions (1) each forming with the adjacent restriction an angle of rotation of 90 degrees, and is equipped with a UV-A lamp (not shown in FIG. 13) with a power of 15 W. Each restriction (1), with a shape illustrated in detail in FIG. 10A, occupies three quarters of the transverse cross section of the reactor and allows the lamp to pass though its center. All the internal surfaces—wall (3) and restrictions (1)—of the reactor were covered by spraying with 4.0 g TiO₂ (commercially available from Degussa under the trade name P25) for a total surface area of 1 m², the dimensions of each module being 5 □ 5□ 26 cm. It can be calculated, while using the formula disclosed herein-above, that the turbulence index through each reactor module is 9,000,000. Furthermore, the average power able to be received by the photo-catalyst, as measured by means of a Solascop 2000 spectrophotometer (provided with a Cosin diffuser) commercially available from Solatell, is 4 mW/cm².

Ethylene was injected into the tight chamber by means of a syringe until the initial ethylene concentration in the chamber is 9.2 ppmv. The photo-catalytic reactor was then activated by means of the eight UV-A lamps and the ethylene concentration was measured and recorded by means of a gas micro-chromatograph Quadh from Agilent. The residual ethylene concentration was 1.0 ppmv after 150 minutes irradiation and only 0.25 ppmv after 180 minutes irradiation. These data correspond to a rate (calculated at 90% oxidation) of 0.31 μmole of ethylene per hour, per watt of power of the source and per unit (gram per square meter) of surface density of the catalyst.

### EXAMPLE 28

Preservation of Fruits by Means of a Photo-Catalytic Reactor Under Turbulent Flow

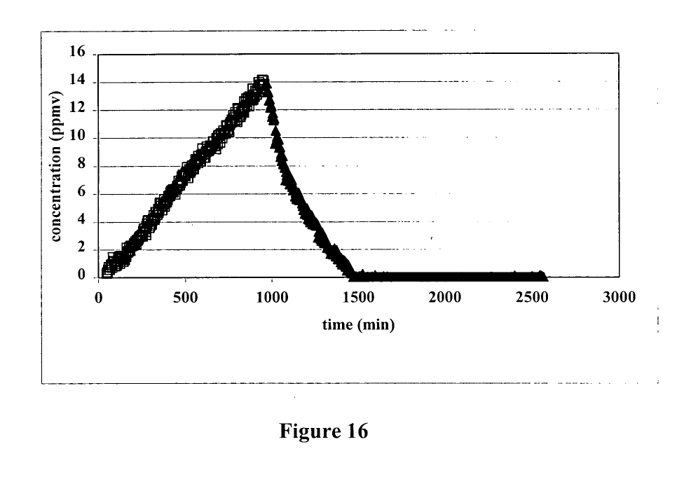

At 28.5° C. and under atmospheric pressure, 9 kg of Granny Smith apples are placed in casings inside the tight chamber of example 23 equipped with the reactor of FIG. 13, i.e. using the same equipment as in example 27. Ethylene concentration is continuously measured and recorded by means of a gas micro-chromatograph Quadh from Agilent, and is shown in FIG. 16. After 950 minutes storage under the above-mentioned conditions, ethylene concentration raises up to 14.0 ppmv. At this point in time, the photo-catalytic reactor was then activated by means of the eight UV-A lamps. As shown in FIG. 16, ethylene concentration was reduced to:

1.4 ppmv only 400 minutes after activating the reactor, and

0.25 ppmv only 600 minutes after activating the reactor.

What is claimed is:

1. A device for the purification of a gaseous effluent comprising contaminants, said device comprising:
a reactor comprising at least one inlet for the gas to be purified and at least one outlet for the purified gas,
at least one source of ultraviolet or visible radiation, and
at least one supporting element positioned inside the reactor and coated with a catalyst forming an exposed catalytic surface capable of at least partially oxidizing the contaminants under the action of ultraviolet or visible radiation supplied by the source,
wherein (i) there is provided, inside the reactor, at least two blocking means, each of said blocking means partially blocking the flow of the gaseous effluent from said inlet as far as said outlet and generating a region of turbulent gas on its downstream side with respect to the flow of the gaseous effluent, the surface of each of said blocking means, as projected onto a plane orthogonal to the longitudinal axis of the reactor, occupying at least ⅓ of the internal cross section of the reactor available for the flow of the gaseous effluent, and (ii) a catalytic surface is positioned in each said region of turbulent gas so that the flow of turbulent gas is incident to said catalytic surface.

2. A device as claimed in claim 1, wherein at least one of said blocking means is a supporting element.

3. A device as claimed in claim 1, wherein it further comprises or else is functionally combined with means suitable for accentuating turbulent flow of the gas to be purified in the reactor.

4. A device as claimed in claim 1, wherein the number and extent of the blocking means, and the internal cross orthogonal cross section and mean internal perimeter of the reactor are selected to ensure turbulent conditions of flow of the gaseous effluent to be purified defined by a turbulence index, calculated according to the formula I_{T}=Re*N/□ f, in which
Re* is a number expressed by Re*=(4ρVₘS)/(Pν),
□=s/S is a porosity parameter, the value of which is equal to 1 if no blocking means is present inside the reactor,
f is a friction factor corresponding to the ratio of the combined surface area in the reactor to the surface area developed by the reactor in the absence of blocking means, equal to the sum of internal surface areas developed by the reactor/surface area of a cylinder with a perimeter P,
S is the mean surface area of the internal orthogonal cross section of the reactor in the absence of blocking means,
ρ is the density of the gaseous effluent to be purified,
Vₘ is the mean velocity of the gaseous effluent to be purified parallel to the longitudinal axis of the reactor,
P is the sum of the mean internal perimeter of the reactor and of the mean external perimeter of the smaller geometric envelope comprising the radiation source(s), when the latter is (are) positioned inside the reactor,
ν is the dynamic viscosity of the gaseous effluent to be purified,
N is the number of blocking means in the reactor or else, in the absence of blocking means, is equal to 1, and
s is the mean surface area of the opening defined by the internal orthogonal cross section of the reactor at the greatest extent of the blocking means,
at least equal to 2,000, preferably at least 50,000, and more preferably at least 1,000,000.

5. A device as claimed in claim 1, wherein the blocking means are distributed non-continuously along the longitudinal axis of the reactor.

6. A device as claimed in claim 1, wherein each blocking means lies within a plane positioned at an angle of 60° to 120° with respect to the direction of flow of the gaseous effluent to be purified.

7. A device as claimed in claim 1, wherein the number and the shape of the blocking means are chosen so as to slow down the gaseous effluent to be purified by 10% to 90% with respect to the velocity which the latter would have in the same reactor without blocking means.

8. A device as claimed in claim 1, wherein the interior of the reactor is at least partially covered with a reflective surface.

9. A device as claimed in claim 1, wherein the interior of the reactor is at least partially covered with a reflective surface which is coated with a catalyst capable of at least partially oxidizing the contaminants under the action of ultraviolet or visible radiation supplied by the source.

10. A device for the purification of a gaseous effluent comprising contaminants, said device comprising:
a reactor comprising at least one inlet for the gas to be purified and at least one outlet for the purified gas,
at least one source of ultraviolet or visible radiation, and
at least one supporting element positioned inside the reactor and coated with a catalyst forming an exposed catalytic surface capable of at least partially oxidizing the contaminants under the action of ultraviolet or visible radiation supplied by the source, said supporting element acting as restriction to the flow of the gaseous effluent,
wherein the number and extent of the blocking means, and the internal cross orthogonal cross section and mean internal perimeter of the reactor are selected to ensure turbulent conditions of flow of the gaseous effluent to be purified defined by a turbulence index, calculated according to the formula I_{T}=Re*N/□ f, in which
Re* is a number expressed by Re*=(4ρVₘS)/(Pν),
□=s/S is a porosity parameter, the value of which is equal to 1 if no restriction is present inside the reactor,
f is a friction factor corresponding to the ratio of the combined surface area in the reactor to the surface area developed by the reactor in the absence of restriction(s), equal to the sum of internal surface areas developed by the reactor/surface area of a cylinder with a perimeter P,
S is the mean surface area of the internal orthogonal cross section of the reactor in the absence of restriction(s),
ρ is the density of the gaseous effluent to be purified,
Vₘ is the mean velocity of the gaseous effluent to be purified parallel to the longitudinal axis of the reactor,
P is the sum of the mean internal perimeter of the reactor and of the mean external perimeter of the smaller geometric envelope comprising the radiation source(s), when the latter is (are) positioned inside the reactor,
ν is the dynamic viscosity of the gaseous effluent to be purified,
N is the number of restrictions in the reactor or else, in the absence of restriction, is equal to 1, and
s is the mean surface area of the opening defined by the internal orthogonal cross section of the reactor at the greatest extent of the restrictions,
at least equal to 2,000, preferably at least 50,000, and more preferably at least 1,000,000.

11. A process for the purification of a gaseous effluent using a purification device in accordance with claim 1.

12. A process for the purification of a gaseous effluent using a purification device in accordance with claim 1, whereby 90% of a model impurity consisting of acetone is oxidized at a rate of 1 to 50 μmol of model impurity per hour, per watt of power of the source and per unit (gram per square meter) of surface density of the catalyst.

13. A kit of elements intended to constitute, by assembling, a device for the purification of a gaseous effluent comprising contaminants, said kit comprising:
a reactor comprising at least one inlet for the gas to be purified and at least one outlet for the purified gas,
at least one source of ultraviolet or visible radiation, and
at least one supporting element intended to be positioned inside the reactor and coated with a catalyst forming an exposed catalytic surface capable of at least partially oxidizing the contaminants under the action of ultraviolet or visible radiation supplied by the source,
said kit being characterized in that it comprises at least two blocking means intended to be positioned inside the reactor, each of said blocking means being intended to partially block the flow of the gaseous effluent from said inlet as far as said outlet and to generate a region of turbulent gas on its downstream side with respect to the flow of the gaseous effluent, the surface of each of said blocking means, as projected onto a plane orthogonal to the longitudinal axis of the reactor, occupying at least ⅓ (one third) of the internal cross section of the reactor available for the flow of the gaseous effluent, and in that a catalytic surface is positioned in each said region of turbulent gas so that the flow of turbulent gas is incident to said catalytic surface.

14. The kit of elements as claimed in claim 13, additionally comprising means for accentuating turbulent flow of the gas to be purified in the reactor, such as forced ventilation or thermal convection means.

15. A process for preserving the quality of agricultural products in the gaseous atmosphere of a closed space or room, comprising a treatment step consisting in subjecting said gaseous atmosphere to a photo-catalytic oxidation process according to a turbulent flow regimen.

16. A process according to claim 15, wherein the said turbulent flow regimen is defined by a turbulence index at least equal to 2,000, preferably at least 50,000, more preferably at least 1,000,000.

17. A process according to claim 15, wherein the said gaseous atmosphere contains one or more contaminants accelerating the ripening or development of the agricultural products and wherein the content of these contaminants in the gaseous atmosphere is reduced by the effect of photo-catalytic oxidation under a turbulent flow regime.

18. A process according to claim 15, wherein the said gaseous atmosphere contains ethylene as a contaminant accelerating the ripening or development of the agricultural products and wherein the content of ethylene in the gaseous atmosphere is reduced below 1 ppm by the effect of photo-catalytic oxidation under a turbulent flow regime.
